(19) United States
(12) Patent Application Publication
(10) Pub. No.: US 2013/0006895 A1
(43) Pub. Date: Jan. 3, 2013

(54) Business Method Patent for determining the Financial Viability of Constructing a Recreation Center and a Flexible Commercial Center known as the ROCC

(76) Inventor: J. Brent Burton, Fishers, IN (US)

(21) Appl. No.: 13/535,115

(22) Filed: Jun. 27, 2012

Related U.S. Application Data
(60) Provisional application No. 61/501,756, filed on Jun. 28, 2011.

(51) Int. Cl. G06Q 90/00

(52) U.S. Cl. 705/500

(57) ABSTRACT

A Business Method Patent for determining the Financial Viability of Constructing a Recreation Center and a Flexible Commercial Center known as the ROCC. The complex device is a one of a kind world class facility that will have a positive impact on wellness, fitness, and the economy of the entire community. Included with this complex is a COMMUNITY CENTER that is a private business. The primary goal of the-ROCC is to create a positive impact on the community. The-ROCC will help promote youth, adult, and family wellness; provide one centralized location for community events and will help spur additional, residential and commercial growth.

### CROSS-REFERENCE TO RELATED APPLICATIONS

This application claims the benefit of Provisional Patent Application Ser. No. 61/501756 filed Jun. 28, 2011 by J. Brent Burton and entitled “Business Method Patent for determining the Financial Viability of Constructing a Recreation Center and a Flexible Commercial Center known as the ROCC”.

### FIELD OF INVENTION

This invention relates to a business method that provides an in depth financial analysis of a recreational center building project. More specifically the method is focused on the development of a financial plan to support a business plan by providing an analysis of the potential financial return on the project. This is accomplished by planning the construction of a flexible building structure that has a sports complex as its cornerstone business. The area demographics are studied and the resultant financial return for the building project is predicted for both the main sports draw and the other associated support businesses in the same complex. The analysis gives a concrete, conservative and optimistic, aggressive boundary conditions for an informed business decision to be made and capital funds to be sought. While part of the invention is directly associated with the business method Class 705, the actual and physical result is a well-planned sports and recreational complex included in the Class 52.

### FEDERALLY SPONSORED RESEARCH

Not Applicable.

### SEQUENCE LISTING OR PROGRAM

### Not Applicable.

### BACKGROUND

### Problem Solved and Prior Art

### Problem Solved

The advantages and disadvantages are listed below. However, the problem solved is that most sports complexes are built and structured for specific events. The versatility of having many different uses is lost on the design board. Or, frequently the structures are very large and cumbersome so that only large metropolitan areas may support the structure. Finally, with the advent of so many amateur travel teams replacing and augmenting school supported athletics, Little League, Babe Ruth, etc., the need for fields for practices, games and tournaments continues to increase rapidly. The method used as a business proposition is to gather the regional data on team needs and to design and build a facility with enough versatility to meet those needs. In addition, the complex anticipates other shops, offices, and constant usage that the revenue stream supports the structure even when events are not scheduled.

### Prior Art

A U.S. Pat. No. 6,832,452 was issued to Simens in 2004 that was entitled “Mega pyramid stadium complex”. It demonstrated a mega stadium-convention center complex comprising an impressive pyramid building with a 670-foot pinnacle and a base covering more than 20 acres. The complex contains a 60,000-seat football stadium with a central playing field located more than 180 feet above the ground. The complex lacked the versatility of other sports and did not show a business method for making the structure viable like the ROCC by Burton shown herein. An earlier U.S. Pat. No. 5,921,032 was issued to Labinski in 1999 named a “Convertible sports and exhibition facility and conversion method”. This is a convertible sports and exhibition facility that includes a stadium and arena configurations. Playing fields or surfaces are provided for both the stadium and arena configurations, with at least a portion of the stadium playing field being removable to provide a lower playing surface in the arena configuration. A seating system includes opposite pairs of end and side seating sections. The versatility lacks in comparison to the Burton ROCC. As well, no business method is demonstrated.

Another U.S. Pat. No. 6,293,052 was issued to Varnado, Jr. in 2001 called “Multifunctional complex”. Here is shown a multifunctional complex incorporates multiple uses and comprises a series of upright wall members including a first interior wall dividing the complex into at least a concert hall. A concert hall includes a stage structure excavated below ground level, a truncated annular dance floor surrounding the stage structure also excavated below ground level and a series of truncated pie-shaped audience seating sections radiating upwardly from the dance floor. The stage structure includes a rotatable central stage defining an axis of rotation and a plurality of pie shaped stationary platforms radially about the rotatable central stage. In a U.S. Patent Application Publication 20050049937 provided by Sanders in 2005 which showed a Business method and processing system that focuses on offering, coordinating, fulfilling and delivering an array of knowledge and productivity services that corporate customers require in today's context, the knowledge/business service combinations representing of mission-critical services with intellectual. Another U.S. Patent Application Publication 20070260473 was submitted to Cornacchia in 2007. This was entitled “Business method for use with a mixed-use building having a commercial showroom and a multi-unit structure directly accessible therefrom”. Disclosed is a business method for use with a building comprising a commercial showroom and a multi-occupancy structure directly accessible from the showroom. The method comprises the steps of providing, for compensation, tenancy rights to said showroom to a business associated with a brand; obtaining rights to use the brand in association with said structure; and providing, for compensation, occupancy rights to the units in said structure. Also disclosed is an improved multi-story building of the type having an adjacent road and residential dwelling units disposed on more than one of said stories. The commercial ties to a versatile sports center is not a key component.

Another United States Patent Application Publication 20100174669 was submitted by Higgs in 2010 called “Method of operating a micro-environment within a commercial complex to promote sales of goods and/or services offered for sale by participating retail merchants”. This invention relates to a method of operating a microenvironment located within a common area of a shopping mall adapted to promote the particular goods and/or services offered for sale by one or more participating retail merchants leasing space adjacent to or near the microenvironment. One or more activities can be conducted in the microenvironment including allowing the participating merchant's potential customers to use, try and/or sample the particular products and/or services offered for sale by the merchants, as a means of promoting those goods and/or services, and attracting customers generally to the shopping mall. The business process is unlike the Burton method in that it does not contemplate sports, travelling teams and the commercial shops and offices shown below.

A complete search of patents and publications was completed. As far as known, there are no Business Method Patent for determining the Financial Viability of Constructing a Recreation Center and a Flexible Commercial Center known as the ROCC or the like. It is believed that this business method and versatile building construction are unique in their design and technologies.

### SUMMARY OF THE INVENTION

This invention is a Business Method Patent for determining the Financial Viability of Constructing a Recreation Center and a Flexible Commercial Center known as the ROCC. The method and construction complex known as the ROCC is based on a financial analysis system using the basic demographics of a selected area and studying the true expected financial returns based on the real area demographics. This means that the predicted returns are based on reality of the geographical area. The old-much used clicé “Build it and They will Come” has been the precursor motto of many a failed projects that has resulted in empty complexes around the country.

This innovative Business Method Patent for determining the Financial Viability of Constructing a Recreation Center and a Flexible Commercial Center known as the ROCC provides a solid basis to make an informed business decision on the desired sports complexes and community centers. By coupling the business method process with a very flexible building concept, the expected use and versatility of the complex is greatly increased. This increased use enhances the expected return on the cost to complete the construction. The demographics used are based primarily on local and state events with foresight to host regional and national events when the complex is at full size. The flexibility of the versatile building design permits a wide expanse of sporting events such as softball and youth baseball, football, footsal, tennis, basketball (full and youth), volleyball, soccer, lacrosse, track and field and other sporting events. Likewise there are offices, studios, office villas, restaurants, recreation play areas, and various shops. Other events may be hosted such as catered banquet capabilities, trade show, conventions and exhibitions, graduations and proms, center court sporting events, concerts, and the like.

The preferred embodiment of the Business Method Patent for determining the Financial Viability of Constructing a Recreation Center and a Flexible Commercial Center known as the ROCC take separate forms. The business method is comprised of several steps including but not limited to:

1 Select Geographical Area for Project Study

2 Determine Local Support and Governing Bodies

3 Select Cornerstone Sport

4 Obtain Local Demographics

5 Complete Financial Analysis & Project Options for Scope

6 Select Scope & Original Size

7 Review & Communicate

8 Foster Public Awareness

9 Obtain Local Approval

10 Obtain Capital Financing

11 Build

12 Launch

13 Decide to Expand

The preferred embodiment of a Flexible Commercial Center known as the ROCC is comprised several elements including but not limited to:

1. Parking Lot

2. Fitness Center Utilization

3. Executive Offices

4. Common Areas

5. Recreational Studios

6. Retail Studios

7. Food Court

8. Hardwood/Sport Court Pods (4)

9. Turf Pods (2)

10. Storage Areas

11. Hotel

12. Plaza

Wherein all elements are comprised of special features

Both the newly invented Business Method Patent for determining the Financial Viability of Constructing a Recreation Center and a Flexible Commercial Center known as the ROCC may be enhanced with features and other elements as described below and understood by one skilled in the art of business methods and with commercial sports and recreational facilities well understands.

### OBJECTS AND ADVANTAGES

There are several objects and advantages of the Business Method Patent for determining the Financial Viability of Constructing a Recreation Center and a Flexible Commercial Center known as the ROCC. There are currently no known business methods nor flexible and heavy duty application heating mats that are effective at providing the objects of this invention.

In the commercial construction business, especially when sports and recreation are involved, the emotions and sentiment sometimes outweighs careful and rational review of the financial viability of the project. Towns and cities all believe their location is best. Most people that are part of the decision-making have been exposed to some form of sports and recreation. If they themselves did not participate, then a close friend or relative had some experience. When it comes to the raising of funds and enough capital to support a building project, the project itself becomes part of the problem. Many times the breadth and usefulness of the facility does not support enough “fans” or the season is too limited. In some instances, the sports require such specialized facilities that little or no use is made of the structures outside the normal seasons.

The Business Method Patent for determining the Financial Viability of Constructing a Recreation Center and a Flexible Commercial Center known as the ROCC addresses these shortfalls. The financial analysis bases its results on the demographics of the local geographical area. Some of this analysis is shown in the Appendices 1, 2 and 3 attached to this specification. The other major improvement is the structure itself. The flexibility of the stadium, annex and pods permit several types of sporting events and other social and business events to use the structure itself. This permits use in all seasons, year round. Further enhancements are the stores and shops directly connected to the sports and events being used 24-7. Finally, the inclusion of offices and virtual office complexes combined with recreational and fitness facilities permit the workplace and professional settings to be co-joined to the after hour work-outs and eating establishments. The restaurants and shops alone permit the athletes, their families and spectators to expand the sport and recreation into an all-day offering of food, recreation and shopping. In some embodiments of the Flexible Commercial Center, a hotel is included. That means the facility takes on the 24 hour needs of the its users and visitors by having a sleeping and relaxation location right at the sports center. Some of the benefits of the Business Method Patent for determining the Financial Viability of Constructing a Recreation Center and a Flexible Commercial Center known as the ROCC:
permits a formal financial analysis of the building project
uses local demographics
expands the sports, recreation and events being served by having versatile stadium, pods and annexes that may be easily adapted to various sports and events
combines the sporting structure with shops, restaurants, hotels, offices and studios to broaden the commercial opportunities for the visitor, and
permits visitors to buy goods, food, use office and recreation areas, rest and enjoy the full time when in and around the sporting event that draws the attendance.

Finally, other advantages and additional features of the Business Method Patent for determining the Financial Viability of Constructing a Recreation Center and a Flexible Commercial Center known as the ROCC will be more apparent from the accompanying drawings and from the full description of the device. For one skilled in the art of financial evaluation methods and those skilled in flexible and versatile building architecture and construction techniques, it is readily understood that the features shown in the examples with this method and building structure are readily adapted to other types of financial evaluations and building needs.

### DESCRIPTION OF THE DRAWINGS—FIGURES

The accompanying drawings, which are incorporated in and constitute a part of this specification, illustrate embodiments of the Business Method Patent for determining the Financial Viability of Constructing a Recreation Center and a Flexible Commercial Center known as the ROCC that are preferred. The drawings together with the summary description given above and a detailed description given below serve to explain the principles of the Business Method Patent for determining the Financial Viability of Constructing a Recreation Center and a Flexible Commercial Center known as the ROCC. It is understood, however, that the business financial method and the versatile sport building complex are not limited to only the precise arrangements and instrumentalities shown.

FIGS. 1 A and 1 B are sketches of the general Business method for determining the financial viability of a sport complex and an example of a versatile sport building structure.

FIG. 2 is a flow chart of the Business method for determining the financial viability of a sport complex.

FIG. 3 is a sub-set flow chart of the financial spreadsheet used for the analysis.

FIG. 4 is an artist rendering of a front view to a flexible building complex for a sporting complex.

FIG. 5 is a plot plan of the building complex and surrounding parking lots and terrain for the flexible building complex for a sporting complex.

FIG. 6 is a floor plan of the building complex.

FIG. 7 is a floor plan of the building complex with the stadium, pods, annex, offices and other areas generally identified.

FIGS. 8 A through 8 D show sketches of the general floorplan with the location of common concessions, restrooms, restaurants, and catering kitchens depicted.

FIG. 9 is a sketch of the floor plan showing the recreational area.

FIG. 10 is a sketch of the floor plan showing lobby, gift shop, studios, shops, check-in and commons areas.

FIG. 11 is a sketch of the floor plan showing the executive offices and office villas for use 24-7 but especially during the normal work week.

FIG. 12 is a sketch of the floor plan showing the annex area.

FIG. 13 is a sketch of the general Pods layout where various sporting and other events may be scheduled and set-up for use.

FIGS. 14 A and 14 B show sketches of the Pods area locker and storage and the event catering area.

FIGS. 15 A through 15 D show sketches of the special pods set-up for volleyball, basketball and youth basketball events.

FIGS. 16 A through 16 C show sketches of the special pods set-up for a trade show and a combination tennis, banquet and basketball, thus showing the wide versatility of the set-up modes.

FIGS. 17 A through 17 F show sketches of the special pods set-up for a trade show, a large banquet, tennis, volleyball, and basketball set up for tournaments and other events.

FIG. 18 is a floor plan of the Stadium cornerstone area.

FIG. 19 is a floor plan of the Stadium with various features denoted.

FIG. 20 is a floor plan of the Stadium locker room and refreshment areas.

FIGS. 21 A through 21 D show sketches of the stadium and lockers, restrooms and concession features shown.

FIGS. 22 A through 22 H show layouts of the stadium ready for football, footsal, softball and youth baseball, a center court event, track and field, full size soccer, and lacrosse.

FIGS. 23 A through 23 C show sketches of the stadium in a concert and a convention/trade show layout.

FIGS. 24 A through 24 C show sketches of the mezzanines throughout the complex.

FIG. 25 is a layout of the full plot plan showing the “GREEN” features of the sports complex.

FIG. 26 is a layout of the full plot plan showing an optional skating rink and expanded outdoor playgrounds as another option.

FIG. 27 is a layout of an optional complex with turf fields, pods, hardwood floors and multi-use floors in place as another option for the complex.

FIG. 28 is a plot plan of an alternative building complex and surrounding parking lots and terrain for the flexible building complex for a sporting complex.

FIG. 29 is a layout of the plot and building plans for an alternative building complex for the ROCC.

FIG. 30A is a schematic of the main level of an alternative building. FIG. 30 B is a schematic building cross-section/elevation the alternative building complex.

FIG. 31 is a schematic of the mezzanine level of an alternative building complex for the ROCC.

FIG. 32 is a schematic of the upper level and roof plan of an alternative building complex for the ROCC.

FIGS. 33 A through 33 D are renderings of the alternative building complex from several views.

### DESCRIPTION OF THE DRAWINGS—REFERENCE NUMERALS

The following list refers to the drawings:

| Ref # | Description |
|---|---|
| 30 | General Building Business Method Flowchart |
| 31 | Step 1: Select Geographical Area for Project Study |
| 32 | Step 2: Determine Local Support and Governing Bodies |
| 33 | Step 3: Select Cornerstone Sport |
| 34 | Step 4: Obtain Local Demographics |
| 35 | Step 5: Complete Financial Analysis & Project Options for |
| | Scope |
| 36 | Step 6: Select Scope & Original Size |
| 37 | Step 7: Review & Communicate |
| 38 | Step 8: Foster Public Awareness |
| 39 | Step 9: Obtain Local Approval |
| 40 | Step 10: Obtain Capital Financing |
| 41 | Step 11: Build |
| 42 | Step 12: Launch |
| 43 | Step 13 Decide to Expand |
| 35 | Step 5: Complete Financial Analysis & Project Options for |
| | Scope |
| 35A | Sub-step 5 A: Select Project Study |
| 35B | Sub-step 5 B: Complete Income Analysis from Demographic |
| | Indicators (4) - Executive Officies, Shops and Studios, |
| | Hardwood Courts, Multiuse Floors, Turf Fields, Conference |
| | Centers, Concessions, Event Admissions, Community Pass, |
| | Advertising |
| 35C | Sub-step 5 C: Calculate/Estimate Expenses |
| 35D | Sub-step 5 D: Provide and Review Building Project Budget |
| 35E | Sub-step 5 E: Complete Cash Flow Analysis |
| 35F | Sub-step 5 F: Select Growth Options and Complete Aggressive |
| | and Conservative Options |
| 35G | Sub-step 5 G: Present Options to Support Group for Scope and |
| | Size Selection |
| 50 | Preferred Flexible Sport Building Center Complex as a Recreational |
| | Office Community Center - ROCC |
| 51 | Layout for the Flexible Sport Building Center |
| 51A | Alternative Building Layout |
| 52 | Artist Rendering at Front Section of the ROCC |
| 53 | Plot Plan of preferred ROCC |
| 53A | Alternative Plot Plan for ROCC with components |
| 54 | Parking |
| 55 | Pond, Landscape, and the like |
| 56 | Building Structure |
| 57 | Entry |
| 58 | Stadium |
| 59 | Pods |
| 60 | Annex |
| 61 | Offices |
| 62 | Studios and Shops |
| 63 | Fitness Center |
| 64 | Recreation Room |
| 65 | Concessions (Stands/Refreshments) |
| 66 | Restaurant |
| 67 | Restrooms |
| 68 | Catering Kitchens |
| 69 | Food Court |
| 70 | Batting Cages |
| 71 | Pool/billiards |
| 72 | Climbing Wall |
| 73 | Wellness and Fitness |
| 74 | Gift Shop |
| 75 | General lobby Area and specific lobby per se |
| 76 | Studios |
| 77 | Shops |
| 78 | Check-In |
| 79 | Commons Area |
| 80 | Office Villas |
| 81 | Executive Offices |
| 82 | Pod Locker and Storage |
| 83 | Event Catering Layout |
| 84 | Volley Ball Layout |
| 85 | Basketball Layout |
| 85A | Youth Basketball Layout |
| 86 | Event Dinner Layout |
| 87 | Tennis Layout |
| 88 | Tradeshow |
| 89 | Soccer |
| 90 | Futsal |
| 91 | Football |
| 92 | Lacrosse |
| 93 | Spectator Seating |
| 94 | Main Convertible Turf Field |
| 95 | Ice Rink |
| 96 | Hardwood Courts |
| 97 | Locker Rooms |
| 98 | Soft Ball and Youth Baseball Layout |
| 99 | Special Center Court Layout |
| 100 | Track and Field |
| 101 | Concert |
| 102 | Mezzanine Layouts (Various Options) |
| 103 | Playgrounds |
| 104 | Hotels |
| 109 | Alternative Plot Plan (to 53 and 53A) |
| 110 | Second Alternative complex (Components similar to Complex 50) |
| 111 | 2^{nd} Alternative Building Layout (Similar to 51 and 51) |
| 112 | Elevation/Cross-section of Alternative Building structure of |
| | layout 111 |
| 113 | Mezzanine for Alternative Building Layout 111 |
| 114 | Upper Level and Roof Plan for Alternative Layout 111 |
| 115 | A-D Renderings of Views for Alternative Complex 111 |

### DETAILED DESCRIPTION OF PREFERRED EMBODIMENT

The present development is a Business Method Patent for determining the Financial Viability of Constructing a Recreation Center and a Flexible Commercial Center known as the ROCC. Particularly these financial methods and building structures are related to a business method that provides an in depth financial analysis of a recreational center building project. More specifically the method is focused on the development of a financial plan to support a business plan by providing an analysis of the potential financial return on the project. This is accomplished by planning the construction of a flexible building structure that has a sports complex as its cornerstone business. The area demographics are studied and the resultant financial return for the building project is predicted for both the main sports draw and the other associated support businesses in the same complex. The analysis gives a concrete, conservative and optimistic, aggressive boundary conditions for an informed business decision to be made and capital funds to be sought. While part of the invention is directly associated with the business method Class 705, the actual and physical result is a well-planned sports and recreational complex included in the Class 52.

Being taught here are the ways to analyze a potential sport and recreational building structure and project. The business methods are enhanced by using local demographics. The actual use of the facility is expanded by having a highly versatile stadium, sports pods and annexes with great support in the common areas. The financial draw is further expanded by coupling the sporting event with everyday offices, shops and studios around the facility. In addition, the complex has eating, recreation and hotel facilities to answer the needs and demands of the locals that use the facility during the work week and the visiting athletes, their families and the spectators that attend the various sporting events.

The advantages for the Business Method Patent for determining the Financial Viability of Constructing a Recreation Center and a Flexible Commercial Center known as the ROCC are listed above in the introduction.

The preferred embodiment of the Business Method Patent for determining the Financial Viability of Constructing a Recreation Center and a Flexible Commercial Center known as the ROCC vary from the method and the structure. The business method is comprised of several steps including but not limited to:

1 Select Geographical Area for Project Study

2 Determine Local Support and Governing Bodies

3 Select Cornerstone Sport

4 Obtain Local Demographics

5 Complete Financial Analysis & Project Options for Scope

6 Select Scope & Original Size

7 Review & Communicate

8 Foster Public Awareness

9 Obtain Local Approval

10 Obtain Capital Financing

11 Build

12 Launch

13 Decide to Expand

The preferred embodiment of a Flexible Commercial Center known as the ROCC is comprised several elements including but not limited to:

1. Parking Lot

2.Fitness Center Utilization

3. Executive Offices

4. Common Areas

5. Recreational Studios

6. Retail Studios

7. Food Court

8. Hardwood/Sport Court Pods (4)

9. Turf Pods (2)

10. Storage Areas

11. Hotel

12. Plaza

Wherein all elements are comprised of special features

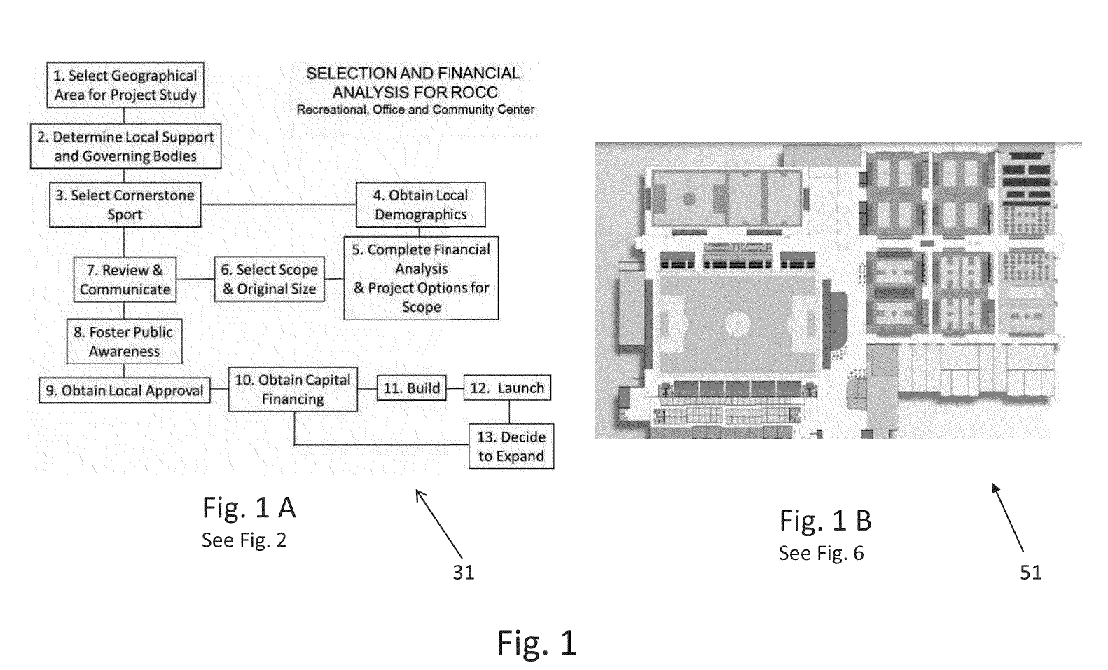

There is shown in FIGS. 1-33 a complete description and operative embodiment of both the Business Method Patent for determining the Financial Viability of Constructing a Recreation Center and a Flexible Commercial Center known as the ROCC. The FIGS. 1-3 demonstrate the Business Method and FIGS. 1 and 4 through 33 the versatile building structure and its alternatives. The manner of using the method and the structure are in the operation and use section, below.

The accompanying drawings, which are incorporated in and constitute a part of this specification, illustrate embodiments of the Business Method Patent for determining the Financial Viability of Constructing a Recreation Center and an embodiment of a Flexible Commercial Center known as the ROCC that are preferred. The drawings together with the summary description given above and a detailed description given below serve to explain the principles of the method and structure. It is understood, however, that the Business Method Patent for determining the Financial Viability of Constructing a Recreation Center and a Flexible Commercial Center known as the ROCC are not limited to only the precise arrangements and instrumentalities shown. Other examples of Business Methods and their uses are still understood by one skilled in the art of financial analysis methods that permit them to be within the scope and spirit shown here with this demonstrated business method. Further other examples of versatile sporting structures and their uses are still understood by one skilled in the art of versatile building structures that permit those other buildings to be within the scope and spirit shown here by this demonstrated building structure.

FIGS. 1 A and 1 B are sketches of the flowchart of general Business method 30 for determining the financial viability of a sport complex and an example of a layout 51 for a versatile sport building structure 50 called the ROCC. A Recreational Office Community Center (ROCC) would provide space for athletics, recreation, fitness, offices, shops, conventions, conferences, and other community programs and events.

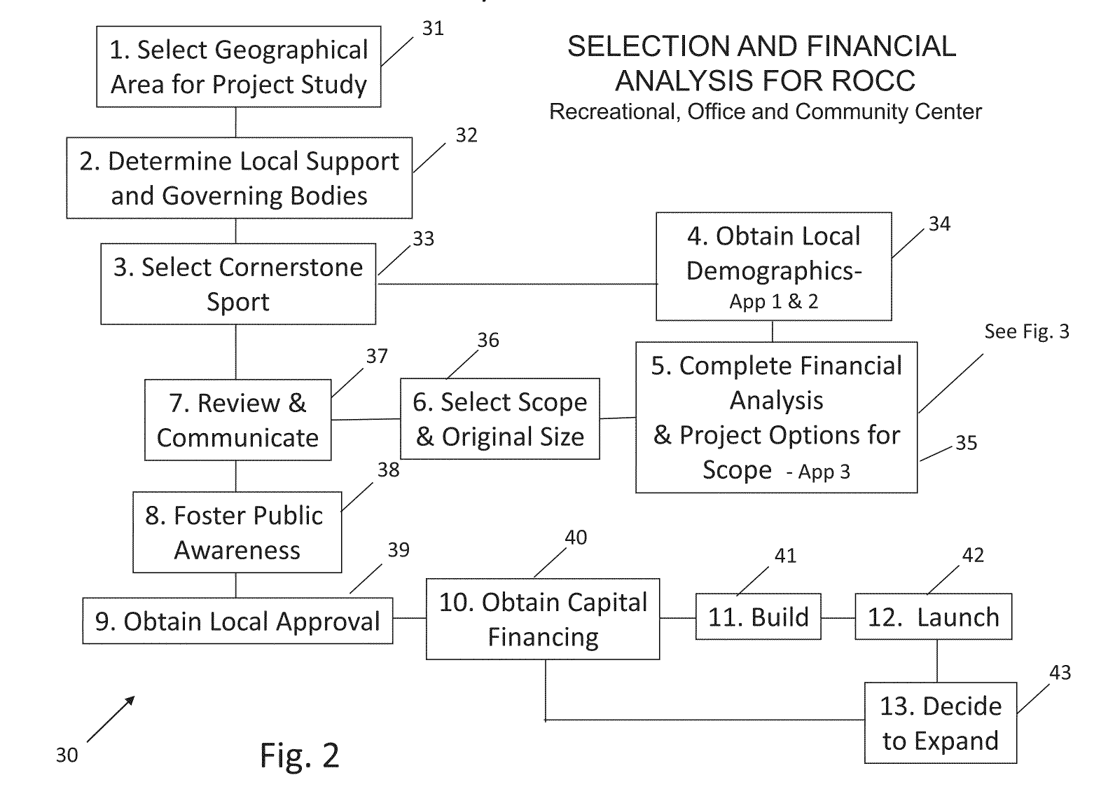

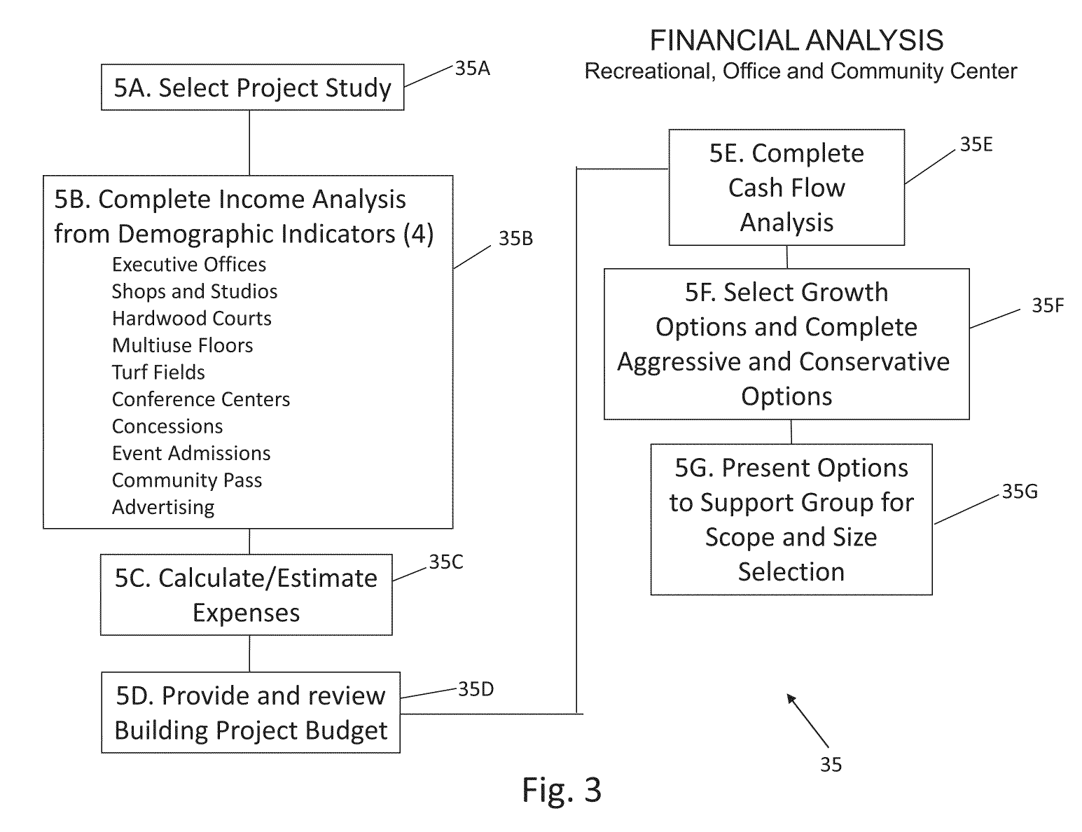

FIG. 2 is a flow chart of the Business method 31 for determining the financial viability of a sport complex. FIG. 3 is a sub-set flow chart of the financial spreadsheet 35 used for the analysis. These are described in detail in the operations section included below.

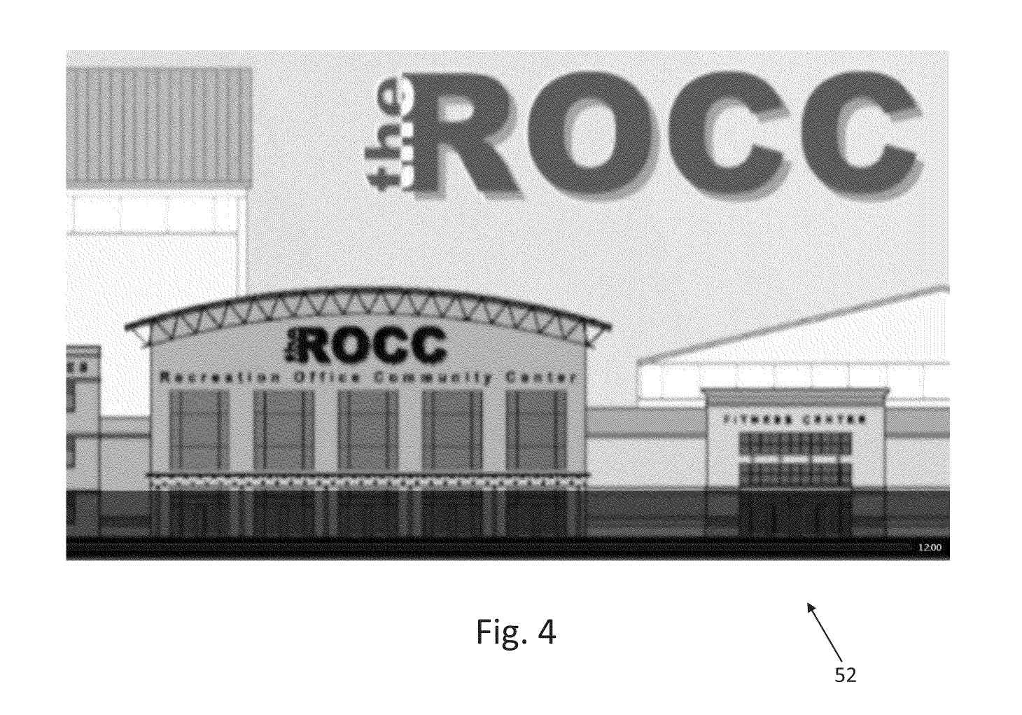

FIG. 4 is an artist rendering of a front view 52 to a flexible building complex 50 for a sporting complex. It is a one of a kind world class facility that will have a positive impact on wellness, fitness, and the economy of the entire community. Included with this is a COMMUNITY CENTER that is private business. The primary goal of the-ROCC is to create a positive impact on the community. The-ROCC will heap promote youth, adult, and family wellness; provide one central zed location for community events and will help spur additional residential and commercial growth. By using local businesses for development. and construction, generating new employment opportunities, and creating a destination for out of town tournament and convention guests, the-ROCC will provide a positive economic impact and enhance the wellness and fitness of the entire community.

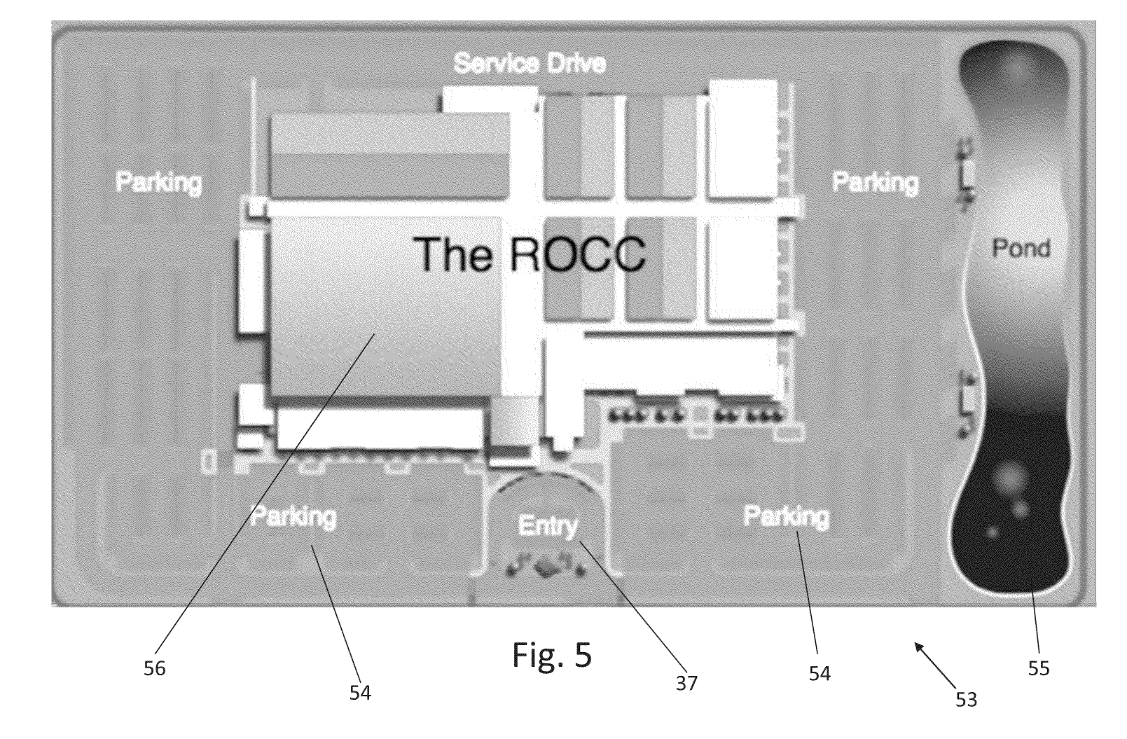

FIG. 5 is a plot plan 53 of the building complex and surrounding parking lots 54 and terrain (ponds 55, landscape, and the like) for the flexible building complex 50 for a sporting complex. Multi-use of the Parking Lot includes:
a. M-F Daytime—Utilized by Executive Offices, Fitness Center, Recreational Activities, Retail Shops, and Food Services
b. M-F Nighttime—Utilized by Hotel Patrons, Pod Activities, Fitness Center, Recreational Activities, Retail Shops, and Food Services
c. Weekends—Utilized by Tournament Attendees, Hotel Patrons, Pod Activities, Fitness Center, Recreational Activities, Retail and Food Services
   The area anticipates having special bus unloading and staging areas; surveillance cameras, lighted parking lot and walk ways; oversized vehicle parking for utility trailers hauling equipment; and camper parking areas complete with electrical hook-ups, water and sewage connections.

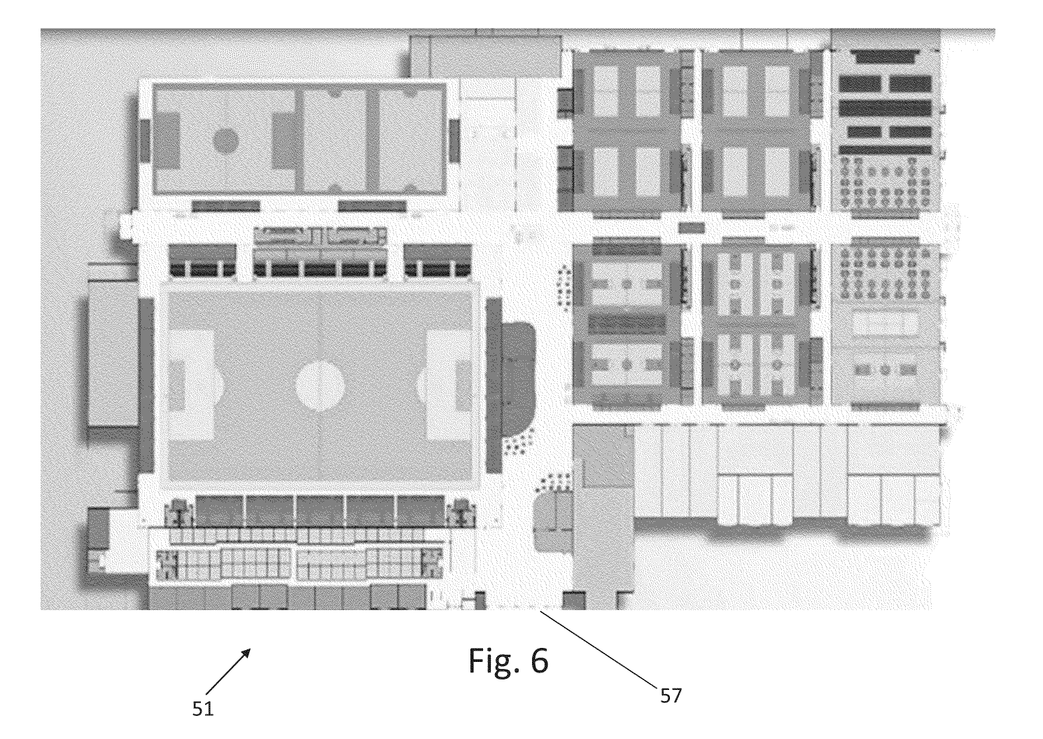

FIG. 6 is a floor plan layout 51 of the building complex.

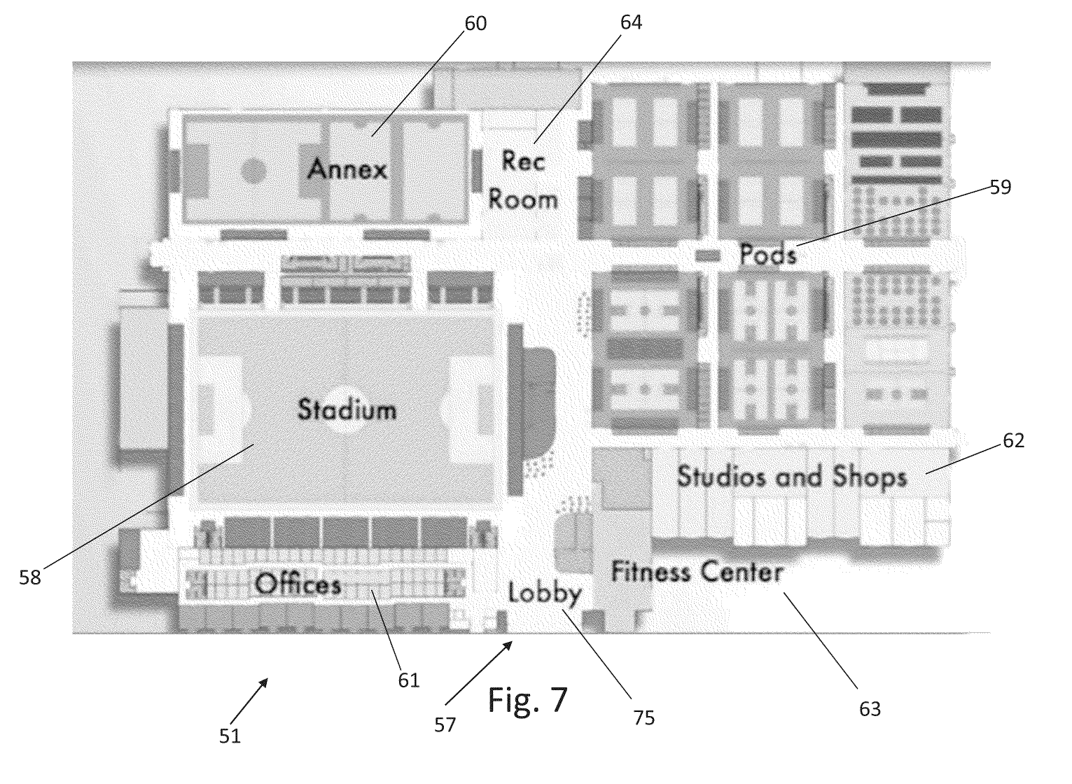

FIG. 7 is a floor plan layout 51 of the building complex 50 with the stadium 58, pods 59, annex 60, offices 61, studios and shops 62, fitness center 63, recreation room 64, and other areas generally identified. Some options have hotels and plazas within the complex. The features include:
Large community community center conferences, recreation, and education programs
A variety of indoor spaces for youth and adult sports and recreation programs
Indoor turf fields that can accommodate soccer, football, lacrosse, softball, and other turf sports
Multi-purpose courts for basketball, volleyball, tennis, and more
Location for churches, private schools, and other community organizations to utilize for social programs, athletics, recreation, and other events
Local venue for school graduations and other large events
Diversified facility offering offices, retail shops and studio spaces
Hotel (optional) with oversized team rooms with bunk beds; chaperone rooms (connecting to team rooms); limited amenities (reduce overhead); shared facility security and maintenance
Plaza (optional)with outdoor play grounds and picnic areas; outdoor concert area; host car shows/craft shows; and vendor areas for special events.

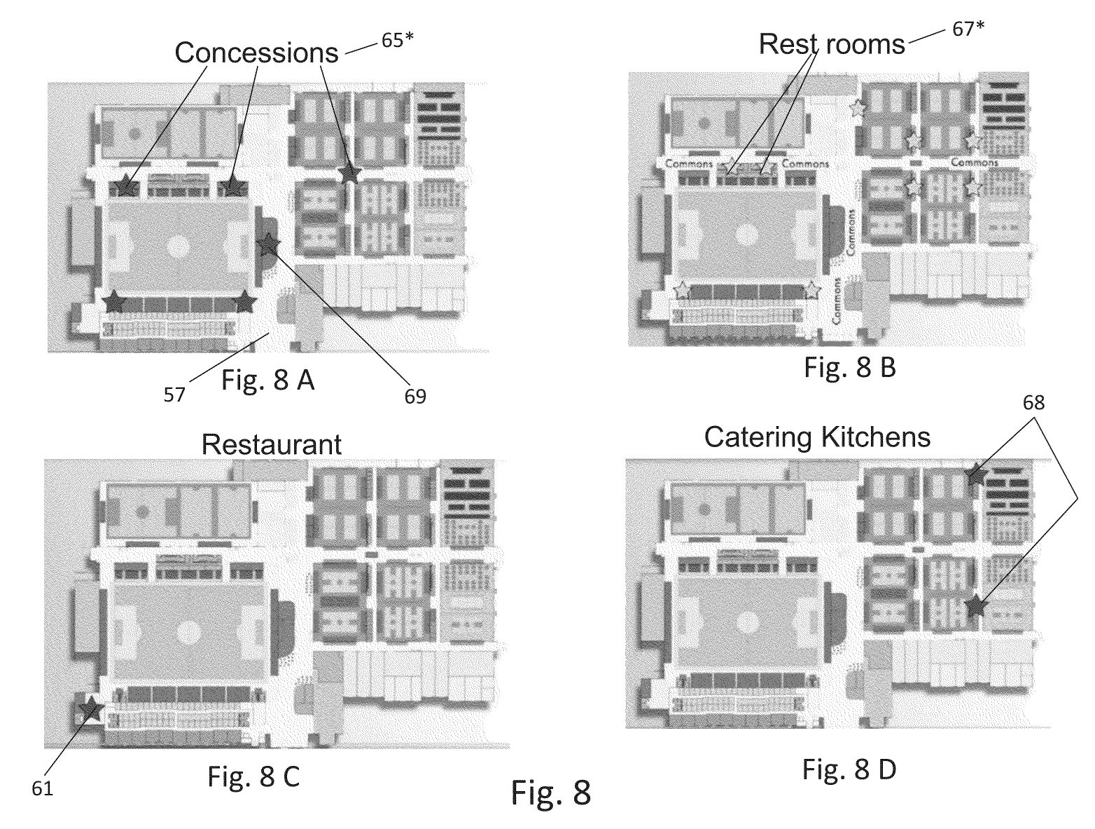

FIGS. 8 A through 8 D show sketches of the general floor plan with the location of common concessions 65, food courts 69, restrooms 67, restaurants 66, and catering kitchens 68 depicted. The Food Court 69 anticipates:
a. Nutritional vendors—Sub sandwiches, Gourmet Deli, Salads, Pizza, Wraps, Smoothies, Coffee, Espressos;
b. Convenience store vendor—Water, pop, sports drinks, chips, cookies, candy;
c. Corporate Vendors—McDonalds, Subway, Taco Bell; and
d. Shared seating areas.

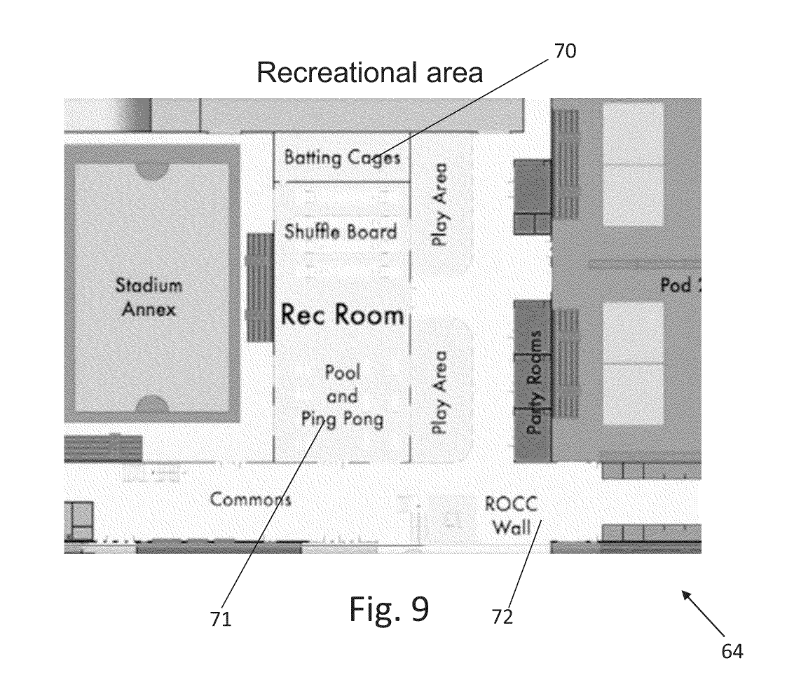

FIG. 9 is a sketch of the floor plan showing the recreational area 64. This area will have batting cages 70, pool/billiards 71, climbing wall 72, and similar activities.

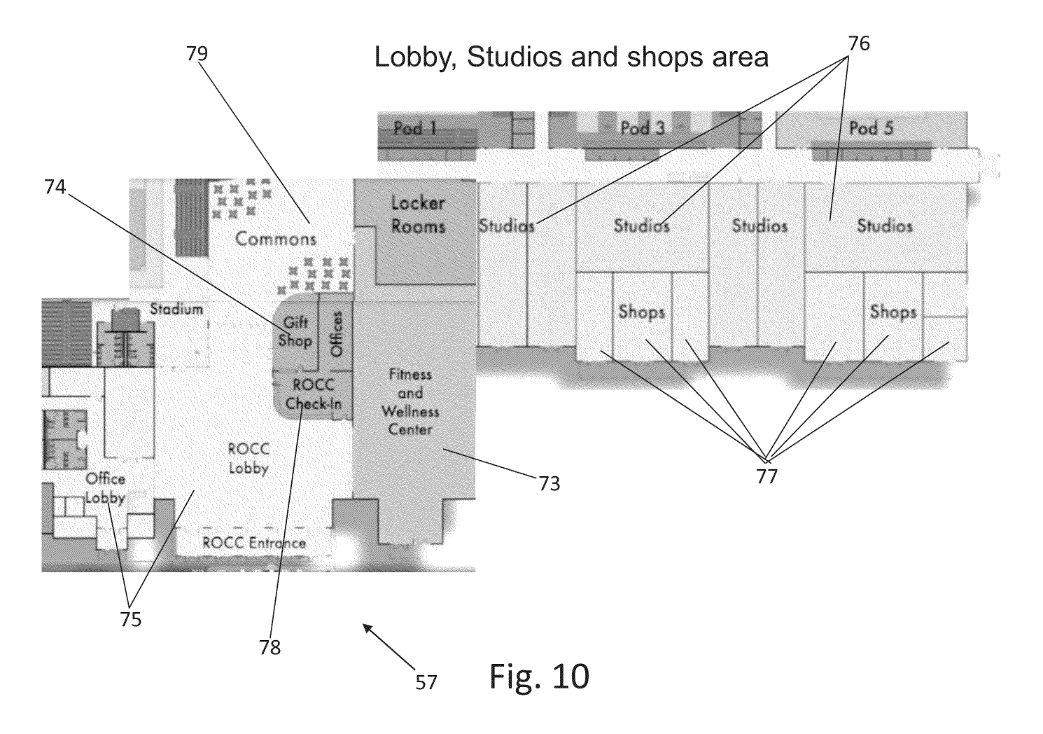

FIG. 10 is a sketch of the floor plan showing lobby 75, gift shop 74, studios 76 , shops 77, check-in 78, commons areas 79, and a wellness center 73.

a. RETAIL SHOPS 77
The-ROCC limited number of retail spaces available for lease. Sports-related businesses will complement the overall fitness and wellness aspect of the facility. The-ROCC also houses a coffee shop and sandwich deli which is conveniently located for office and athletics patrons. Other salient points for the Retail Studios are accommodations for specialty stores—Athletic Footwear, Sports Apparel, Sports Equipment and accommodations for Health Stores—Sports Nutrition, Vitamin and Supplement Providers.

b. STUDIO SPACES 76
Time management is crucial for families, especially multi-sport families. An unique multi-sport facility is designed with this concept in mind. The-ROCC has recreational studios with: accommodations for recreational activities—Dance, Cheer, Martial Arts; accommodations for hobby and special interest groups—Art Classes, Card Clubs, Computer Training Courses; accommodations for fitness activities—Zumba, Jazzercise, Yoga, Pilates; team meeting room and film review areas; and studio tenants able to host large events/competitions in other areas.

c. COMMONS 79
The spacious commons area has visitor comfort in mind. The lobby has plenty of congregation space to wait for family members or friends. The large concessions area operates extended hours with healthy food choices in addition to the usual concession food items. Satellite concessions are located throughout the facility to accommodate larger events. The commons area provides a variety of seating for guests having a meal or snack break. Additional seating areas throughout the facility are perfect for team meetings or other gatherings. There are plenty of restrooms located throughout the-ROCC, including family restrooms or quests with small children.

Other features in the Common Areas Include: Indoor Park-Benches, Picnic Areas, Playgrounds; Large Restrooms, Changing Areas, Personal Lockers; Walking Areas; Food Court; and Surveillance Cameras.

d. Wellness center 73
One may start the day with WELLNESS/FITNESS. At the-ROCC a person begins the new day with a workout at the community fitness center. The affordable, state of the art fitness center has the all the expected amenities such as cardio and weight training, clean locker rooms and showers. The-ROCC not only has a common area for general fitness, but also has specialized training areas for the serious athlete. Space is available for Pilates, yoga, spinning, nutrition and wellness classes. The ROCC can accommodate everyone from the beginner who is just starting a wellness routine, to the professional athlete needing specialized training. Enjoy ones workout prior to the workday, during lunch, or after business hours. The fitness center is very conveniently located for those leasing space in the-ROCC's executive offices, and for families with children participating in other activities at the-ROCC. The anticipated Fitness Center concept includes:
1) Individual, Family and Corporate Memberships
2) Accommodations for Independent Personal Trainers to provide their services
3) Accommodations for Rehabilitation/Sports Medicine
4) Accommodations for sports clubs and leagues to train and condition
5) Indoor Running/Jogging Track

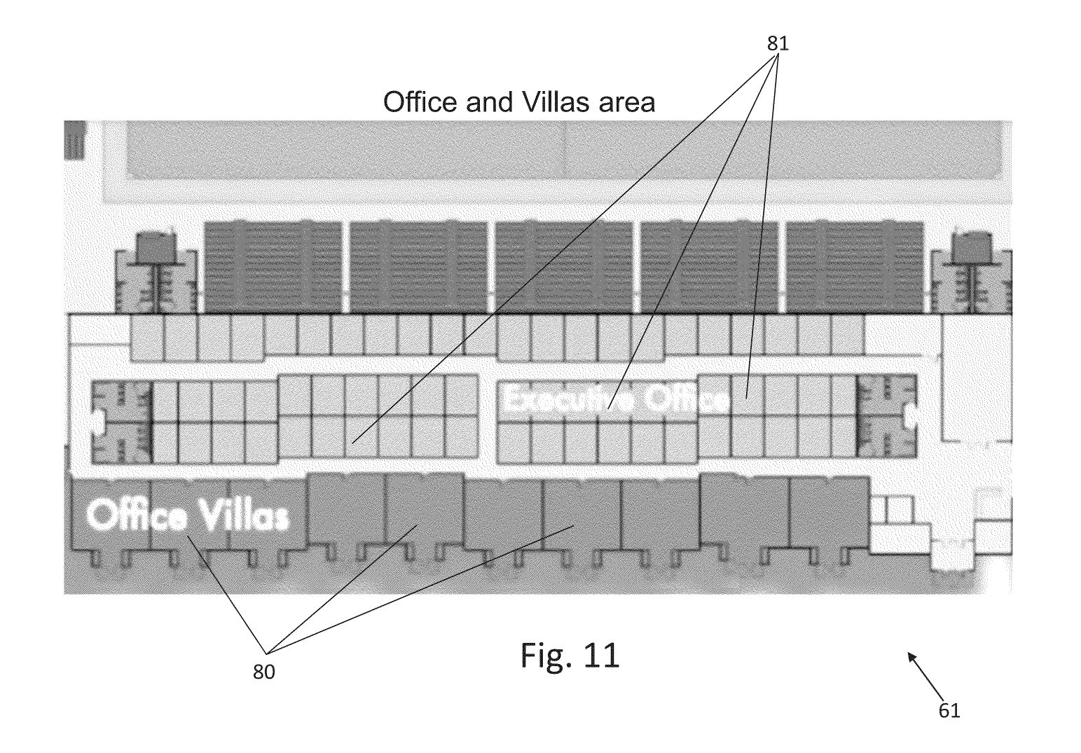

FIG. 11 is a sketch of the floor plan showing the executive offices 81 and larger office villas 80 for use 24×7 but especially during the normal work week. The offices 61 include unique features for the executive offices 81 and villas 80. Executive Offices at the-ROCC are home to a variety of small businesses. The villas 80 and executive offices 81 provide the amenities one would expect. The offices have a spacious community room, and large conference rooms available for tenant use and outside lease. The multi-use facility allows tenants to be only a few steps away from the community fitness center, athletic fields and courts, and close to their family sports and recreation activities. Other features are:
a. Offering various sizes and prices of office spaces to meet the needs of current and perspective customers
b. Shared amenities—rest rooms, conference room, media center, copy/fax machines
c. Receptionist service
d. Onsite Conference/Lecture Hall available to Executive Office tenants and non-tenants
e. Catering Kitchen for Conference/Lecture Hall
f. Facility amenities—Fitness Club, Food Court, Indoor park area, Recreational Activities
g. Surveillance Cameras, lighted walk way and halls

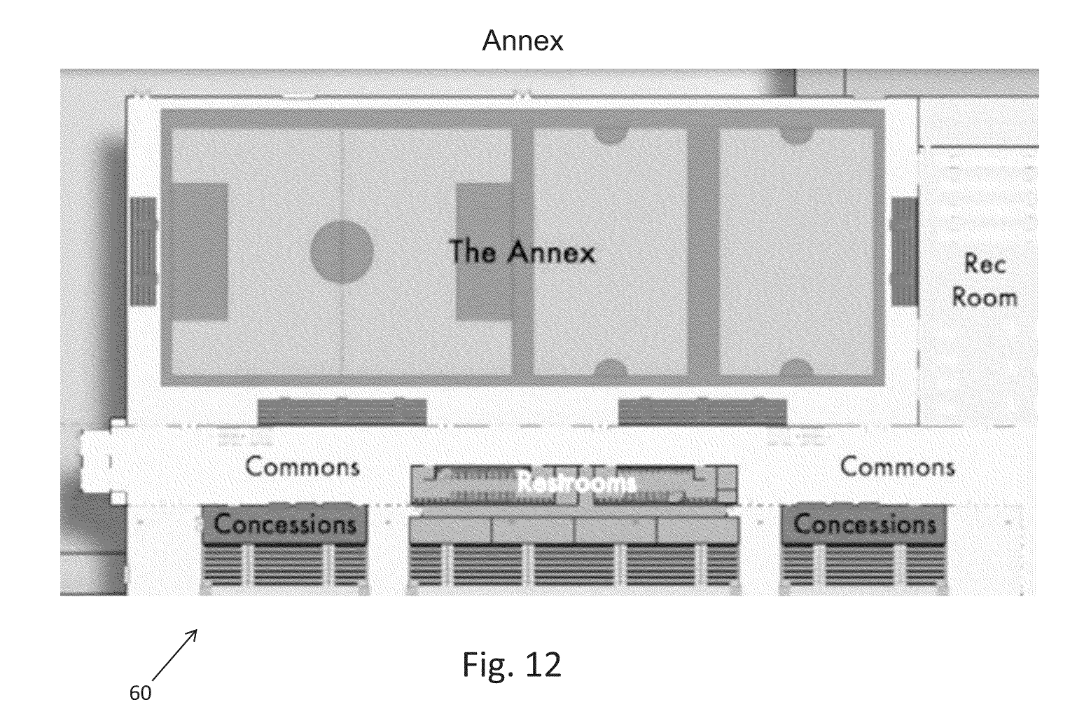

FIG. 12 is a sketch of the floor plan showing the annex area 60. It includes storage areas; team and club storage units; large receiving area for vendor supplies; large warehouse for equipment; and locker rooms for patrons/teams.

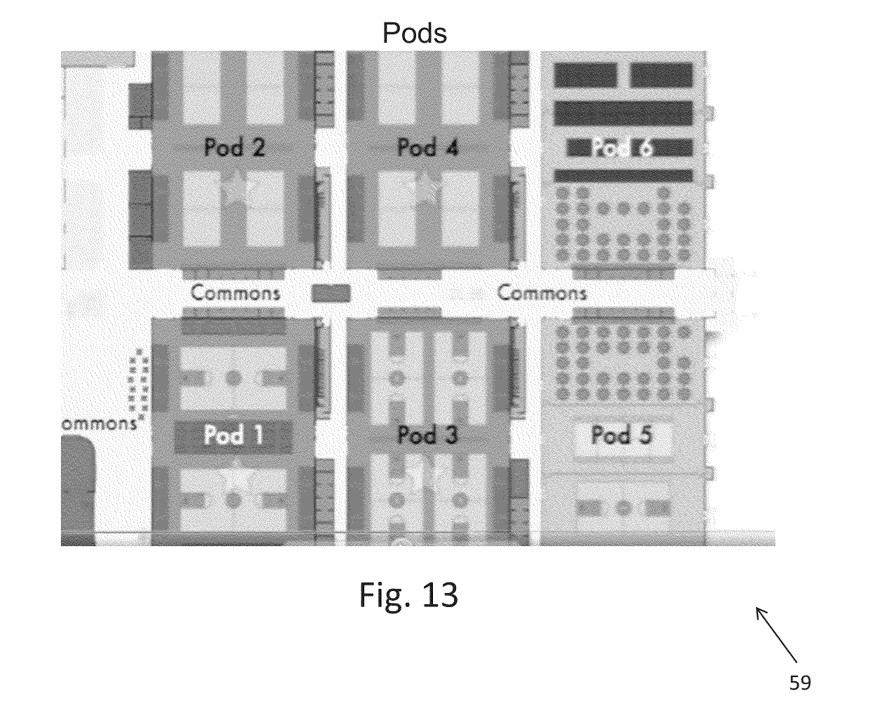

FIG. 13 is a sketch of the general Pods 59 layout where various sporting and other events may be scheduled and set-up for use. This is a key difference from other sport and office complexes. The flexibility to accommodate a plethora of sports is included. The ROCC is dedicated providing the best sporting experience available for all Players, Coaches, Officials, Teams, Leagues and most of all the Spectators.

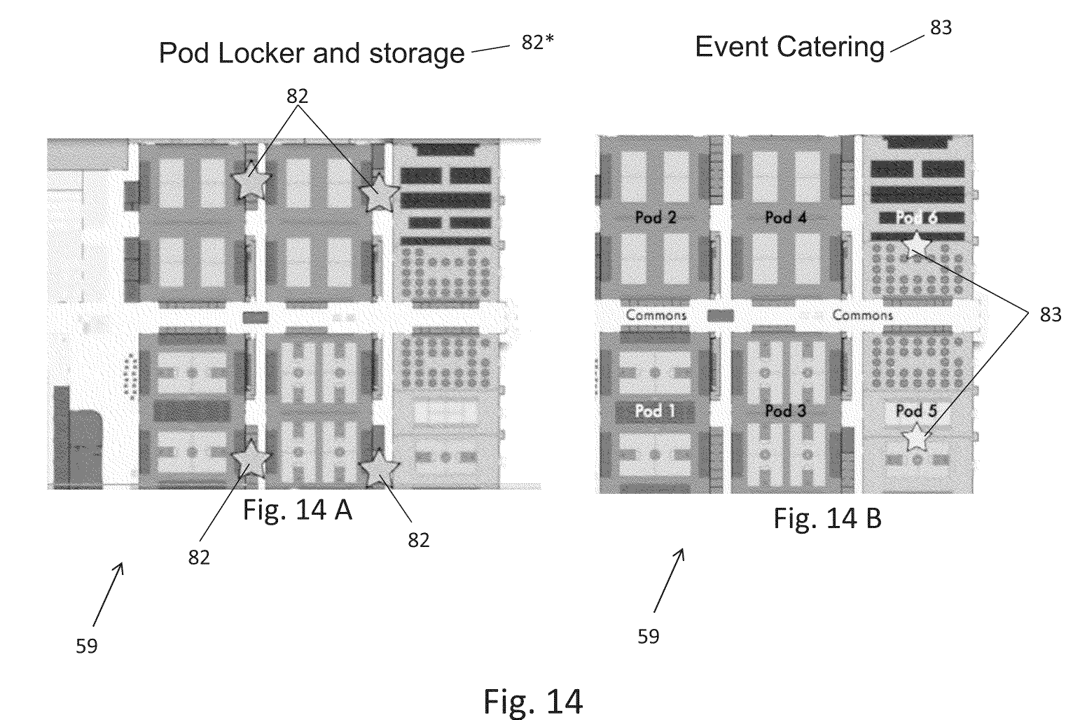

FIGS. 14 A and 14 B show layout sketches of the Pods area 59 locker and storage 82 and the event catering areas 83.

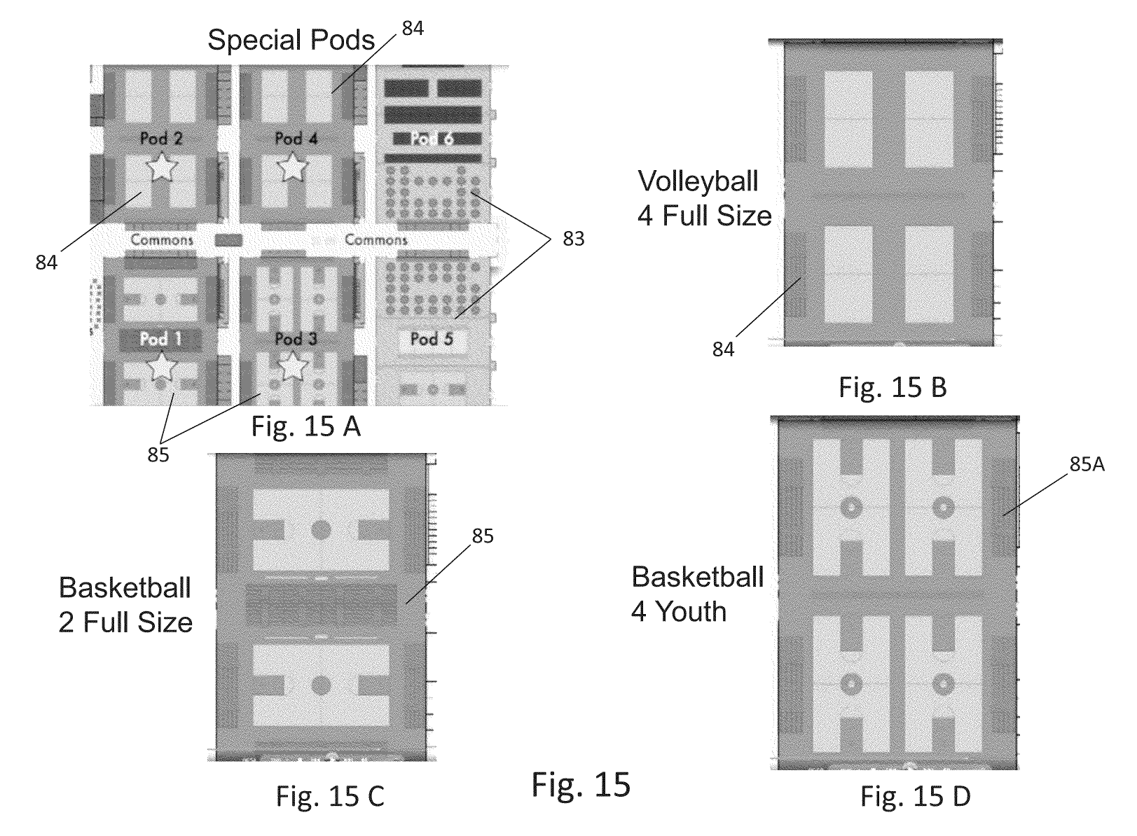

FIGS. 15 A through 15 D show sketches of the special pods set-up for volleyball 84, basketball 85 and youth basketball 85A events.

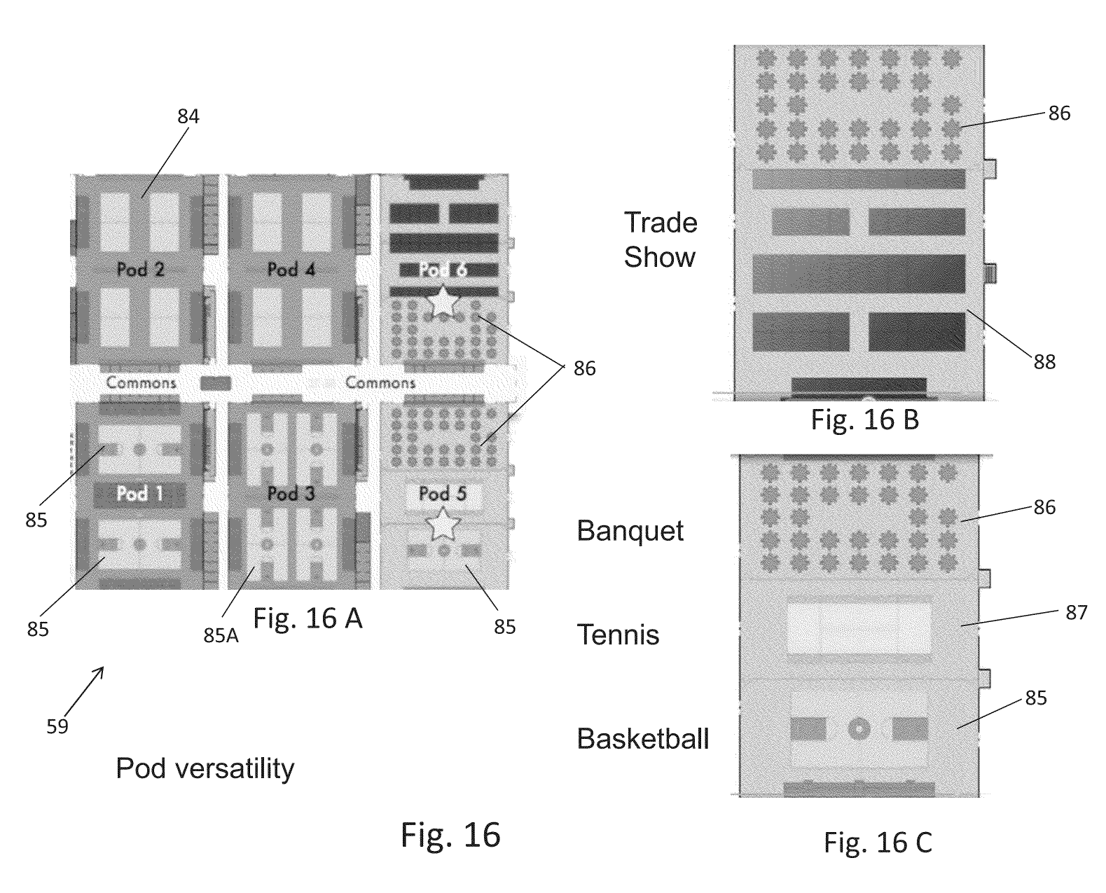

FIGS. 16 A through 16 C show sketches of the special pods 59 set-up for a trade show 88 and a combination tennis 87, banquet event 86 and basketball 85. Thus is the showing of the wide versatility of the set-up modes.

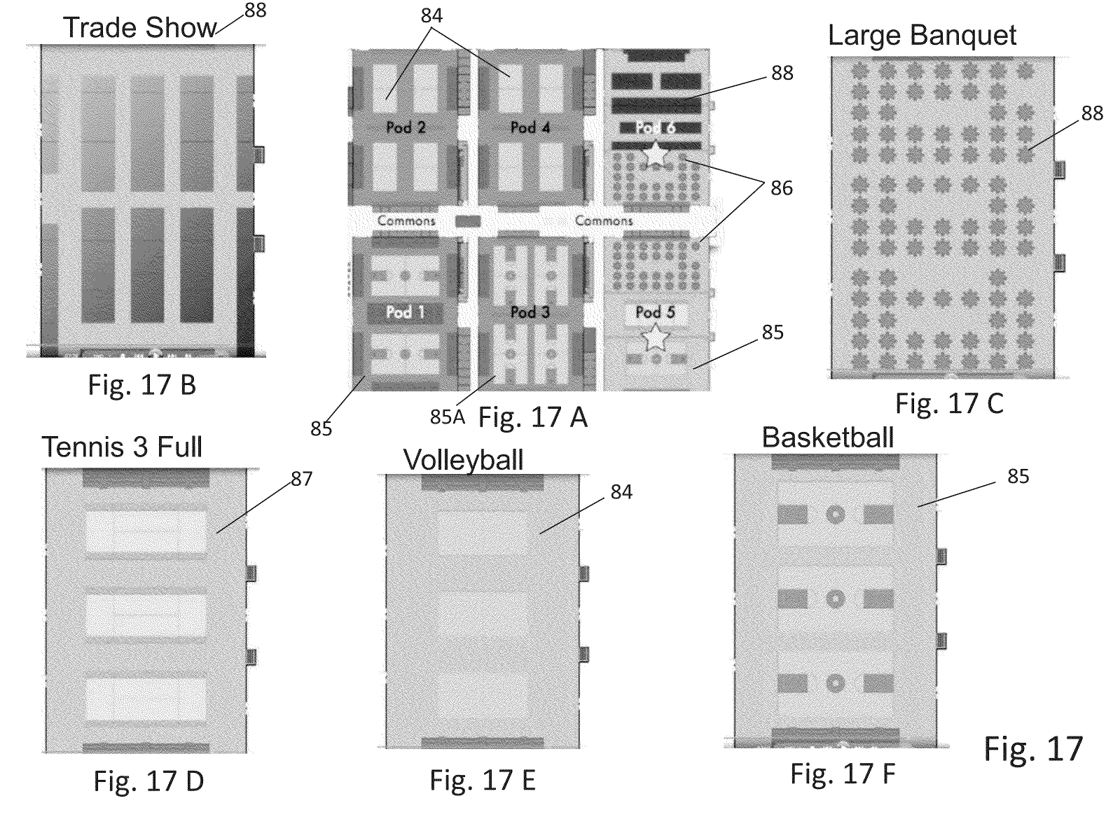

FIGS. 17 A through 17 F show sketches of the special pods set-up 59 for a trade show 88, a large banquet 86, tennis 87, volleyball 84, and basketball 85 set up for tournaments and other events. Athletics are the foundation of the-ROCC. Each of the multi-use athletic spaces, or “Pods” 59 as they are called, is a sports itself. Each “athletic” Pod 59 contains 4 basketball courts, which can convert to 6 volleyball courts. Hardwood floors, ample run-off room, and state of the art scoring systems make the courts desirable for higher level clubs and teams. Each “multi-purpose” Pod has 3 tennis courts which are convertible to volleyball or junior high size basketball courts. Multi-purpose flooring and movable walls make them easily adaptable to banquets or tradeshows of any size. In addition to upper level mezzanine viewing, we've incorporated plenty of bleacher seating and extra space for spectator comfort. Each Pod is separate to provide security, privacy, and sound. control. The courts may easily adapt to practice or training with configurations for other Sports—Futsal, Dodge Ball, Etc.; Configurations for other Recreations—Dance, Cheer, Gymnastics, Martial Arts, competitions and tournaments; Other venues—Concerts (music and other), Conference/Tradeshows, Exhibitions, Graduations, Banquets, etc.

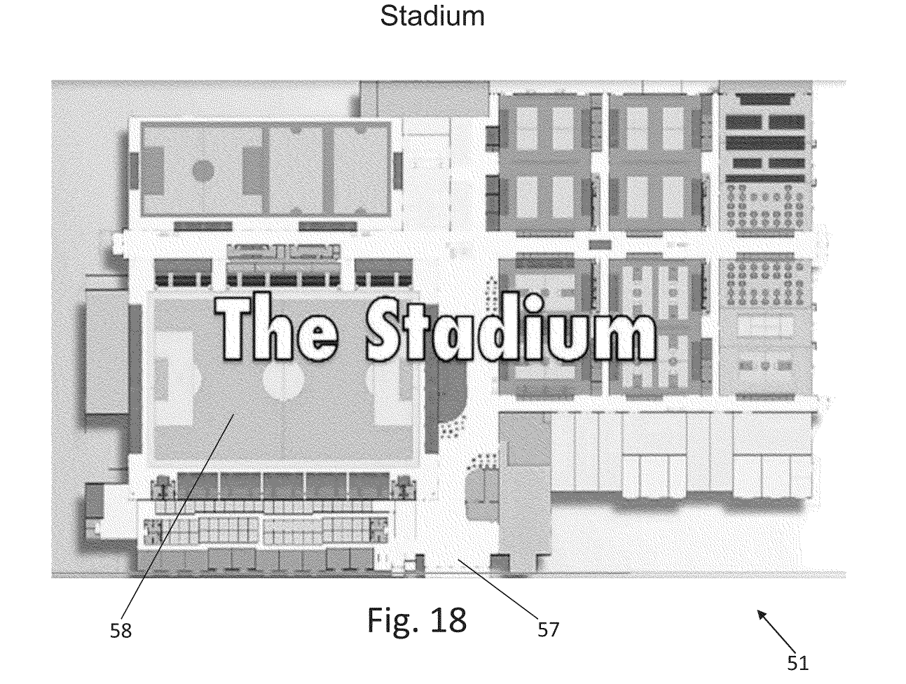

FIG. 18 is a floor plan of the Stadium 58 which is the cornerstone area. The indoor turf Stadium 58 can host. soccer 89, futsal 90, football 91, lacrosse 92, and other turf sports. Mezzanine viewing and plenty of seating make the Stadium spectator-friendly for local, state, and regional competitions and tournaments.

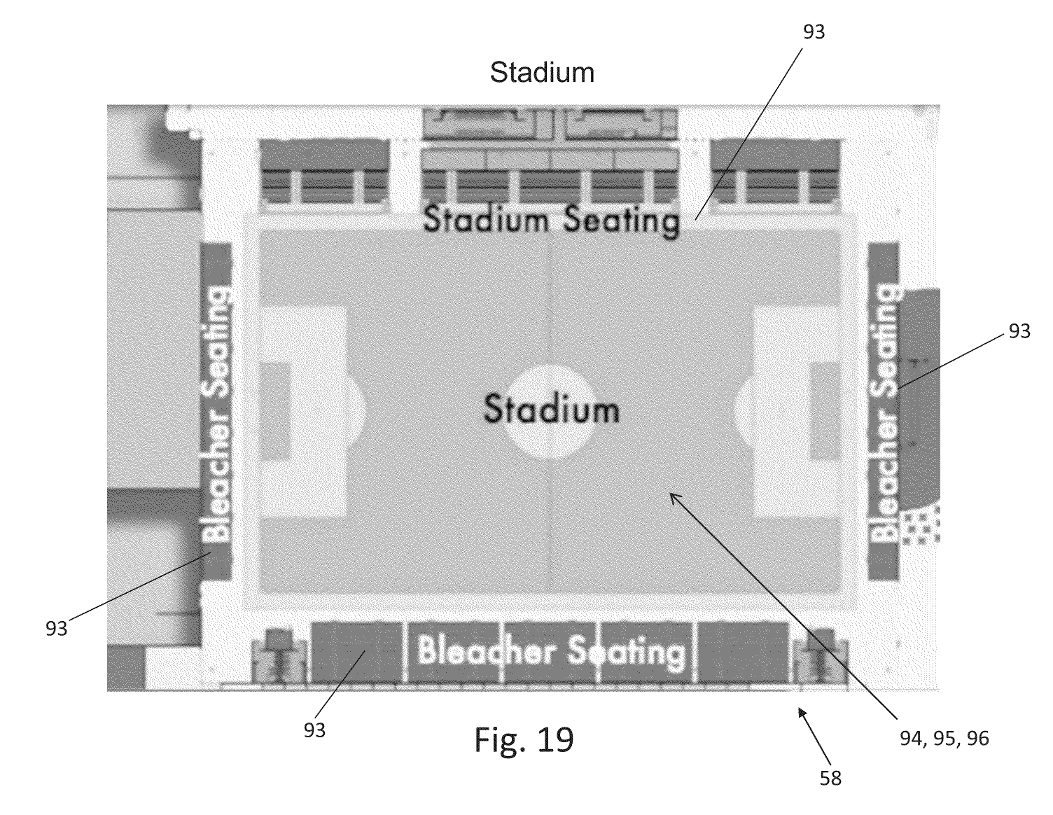

FIG. 19 is a floor plan of the Stadium 58 with various features denoted. The large arena is the focal point for spectators at the-ROCC. The multi-functional Arena easily converts hardwood courts 96, a turf field 94, an ice rink 95, or other specialty flooring in order to accommodate a wide range of athletic and recreational competition. The Arena can also host concerts (music and other), graduation ceremonies, symposiums, and countless other spectator events.

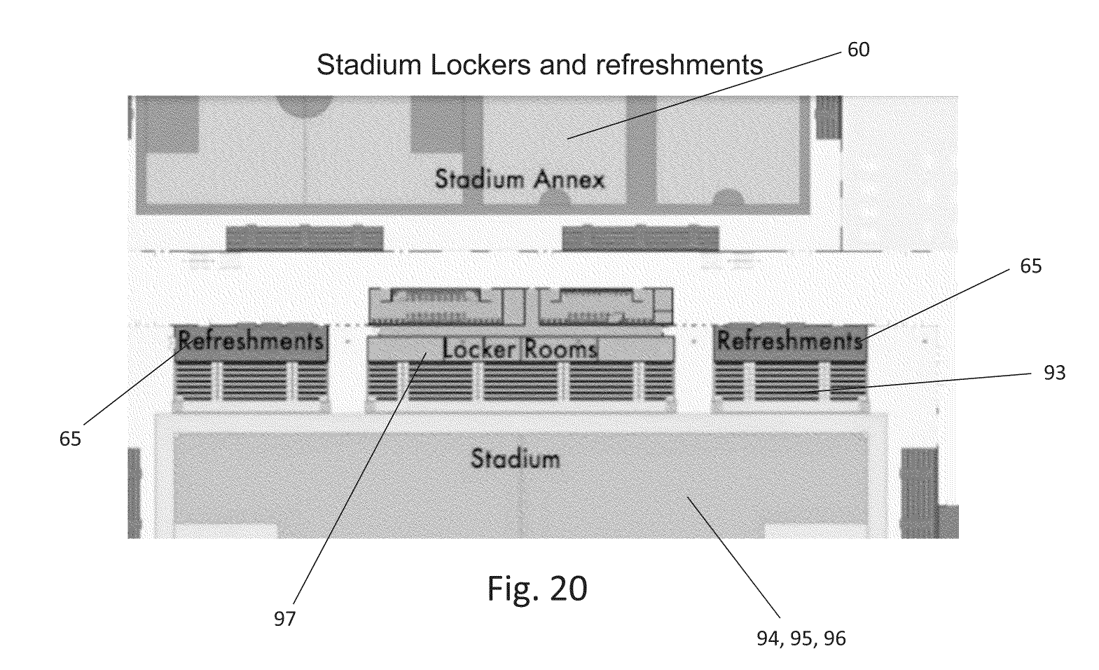

FIG. 20 is a floor plan of the Stadium locker room 97 and refreshment 65 areas. This is between the annex 60 and the stadium areas 58.

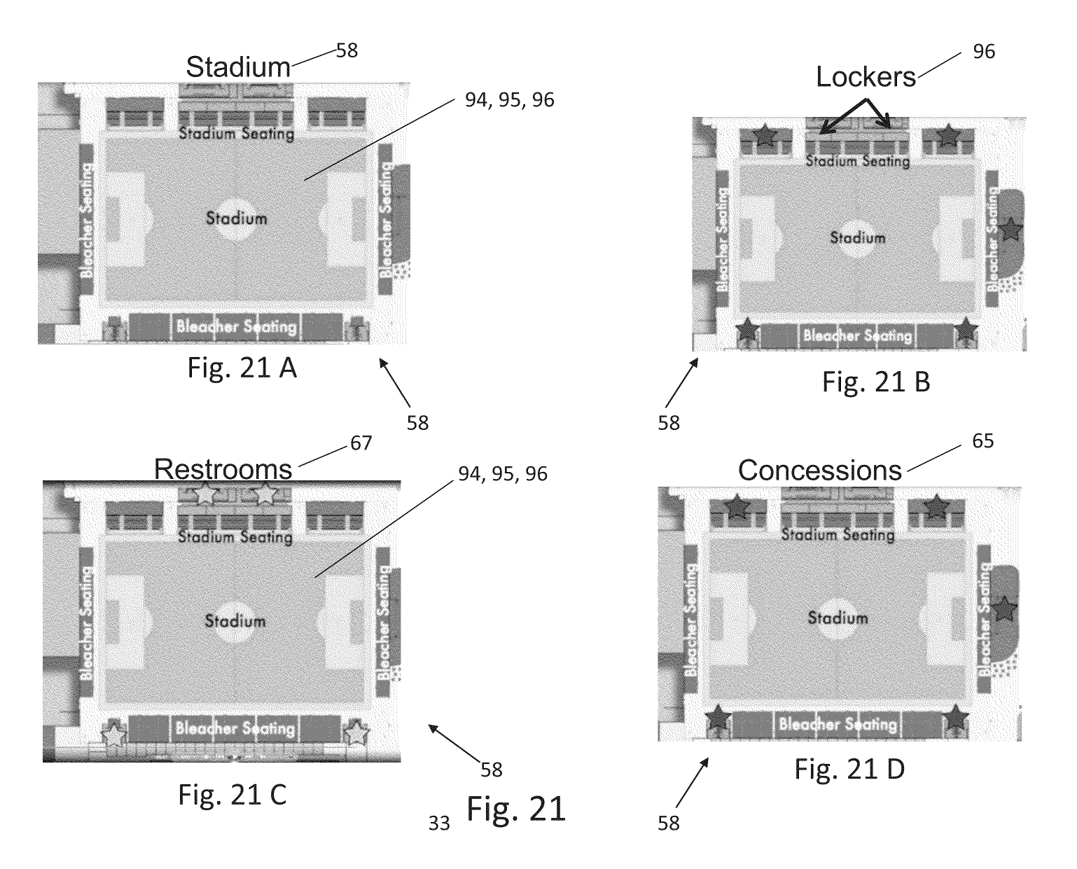

FIGS. 21 A through 21 D show sketches of the stadium 58 and lockers 96, restrooms 67 and concession 65 features shown.

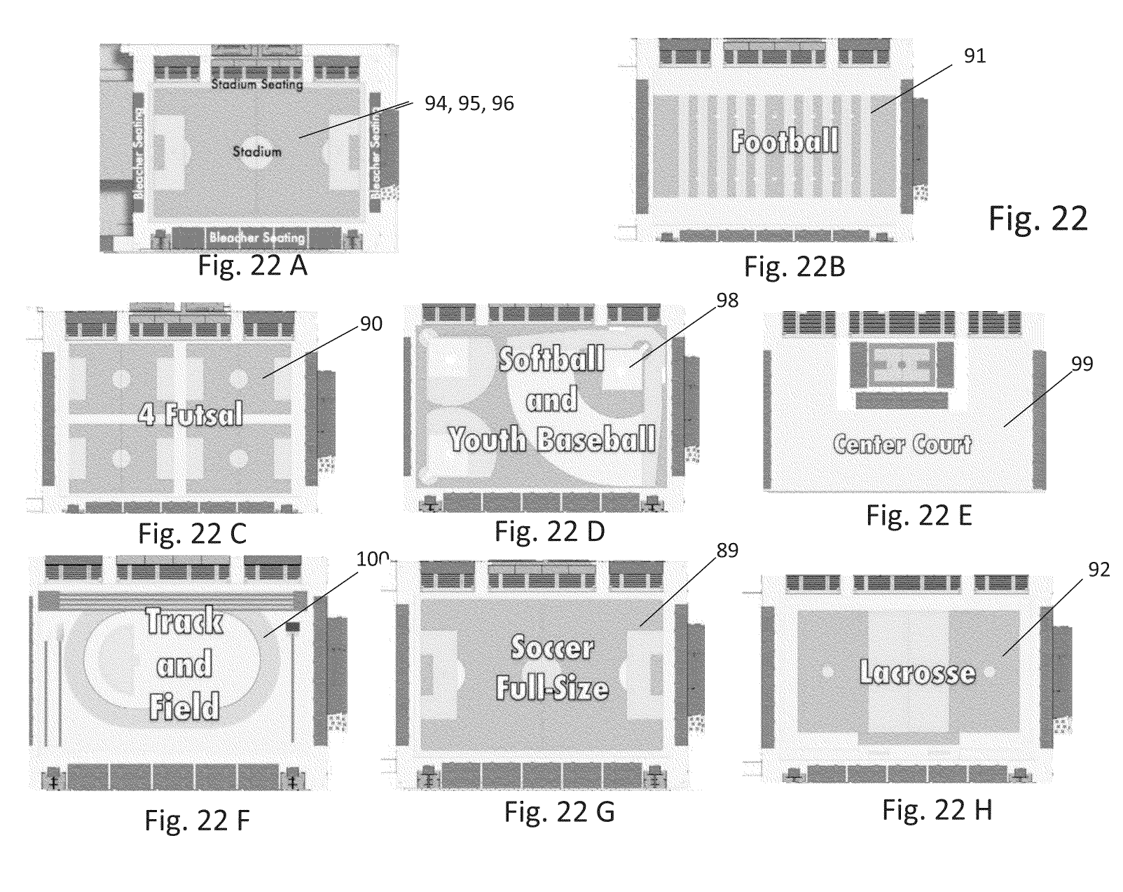

FIGS. 22 A through 22 H show layouts of the stadium 58 ready for football 91, futsal 90, softball and youth baseball 98, a center court event 99, track and field 100, full size soccer 89, and lacrosse 92.

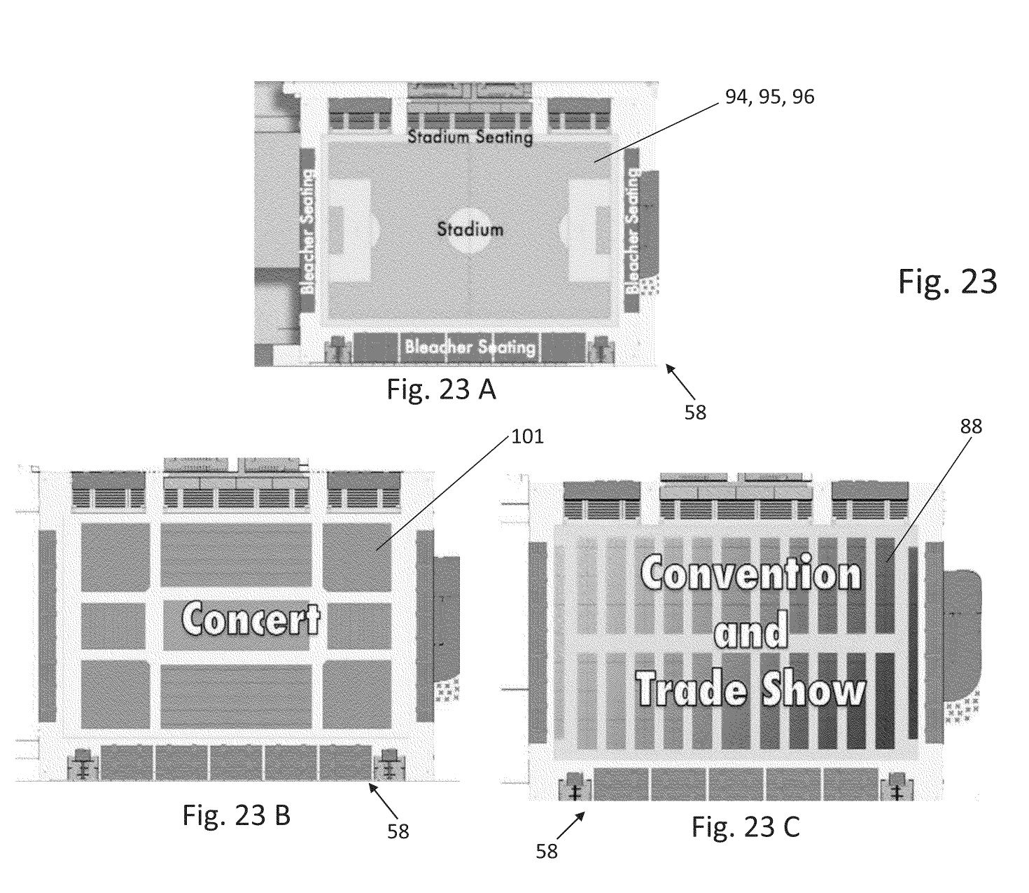

FIGS. 23 A through 23 C show sketches of the stadium in a concert (music and other) and a convention/trade show 88 layout.
A. EVENTS—The ROCC is designed for tournaments and competitions. With state-of-the-art hardwood courts and synthetic turf fields, the-ROCC is capable of hosting athletic tournaments and sporting events of any kind. The-ROCC is perfectly suited for Dance, Cheer, Band, Choir, Martial Arts, and many other types of competitions.
B. CONVENTIONS—To help spur additional growth in the community, the-ROCC is designed to easily host a wide range of conventions and expositions. Each of the Pods can easily convert to a tradeshow or banquet layout. Easily accessible cat ring kitchens and overhead doors for truck delivery add to the ease of event hosting. Secondary entrances and a conference center lobby allow one or multiple Pods to be completely separated for event hosting and security purposes. The Stadium can also be converted to a convention hosting format for very large events. In addition to tradeshows and conventions, the-ROCC is flexible enough to host a variety of other special events including concerts, high school graduations, educational clinics, symposiums, sports camps or preschool programs. With its flexible campus style design, the possibilities of the-ROCC are endless.

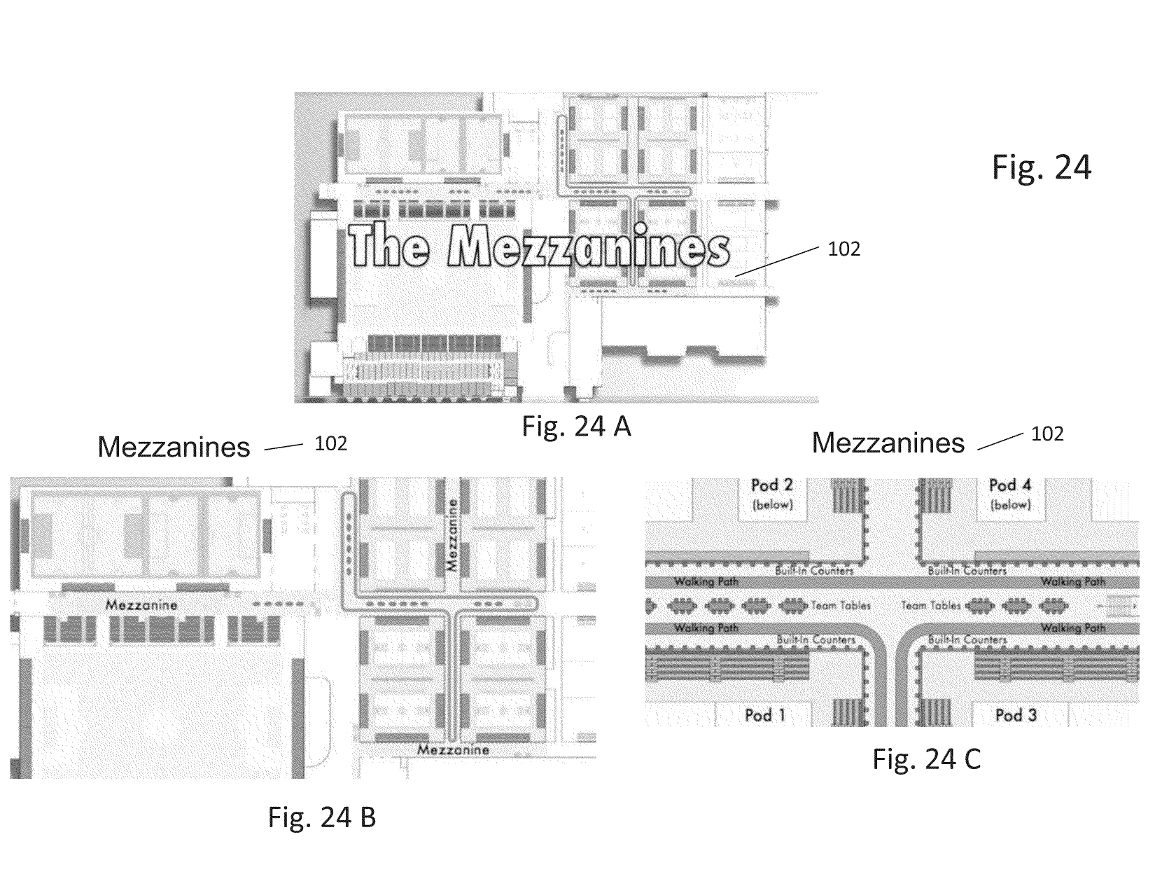

FIGS. 24 A through 24 C show sketches of the mezzanines 102 throughout the complex 50. A unique feature of the-ROCC is the generous mezzanine space. Built in counters birds-eye view of the courts and fields. There are abundant seating and table space for team meetings before and after games.

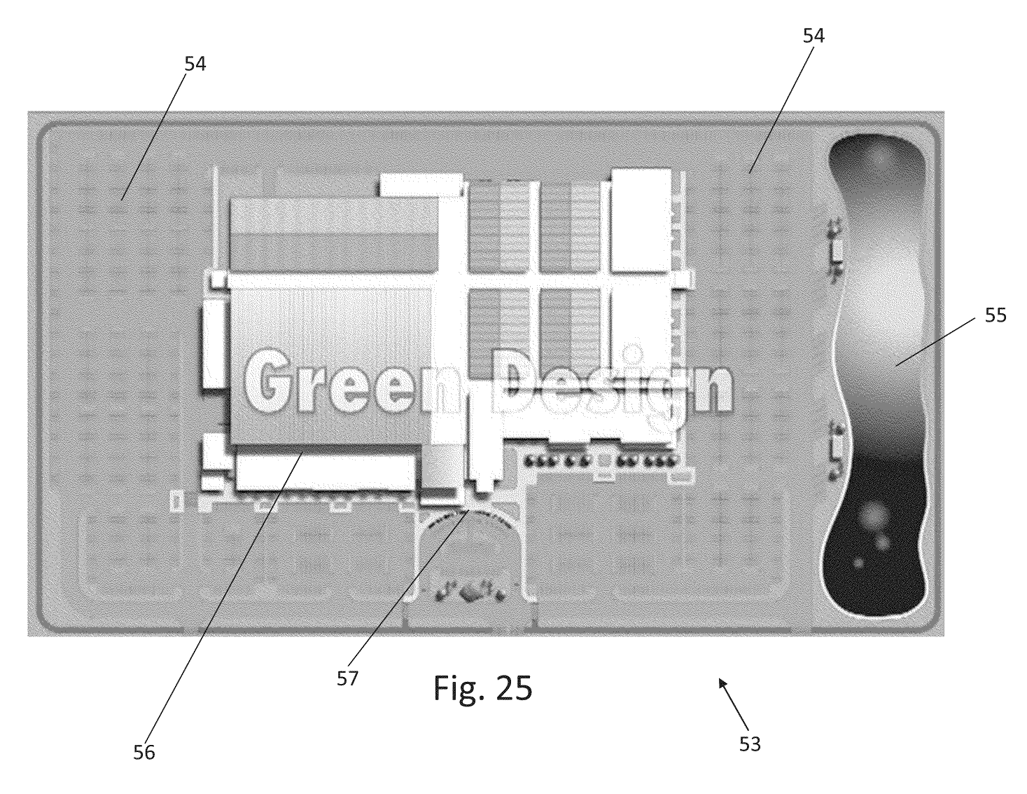

FIG. 25 is a layout of the full plot plan 53 showing the “GREEN” features of the sports complex. Environmental friendly design has a high importance at the-ROCC. Green aspects of the design include ground source geothermal for heating and cooling, harvesting of rainwater for restroom use, and landscaping that cleans storm water in a natural, sustainable way. A highly insulated building, generous amounts of natural light, and quality ventilation and fresh air systems all add to visitors' comfort.

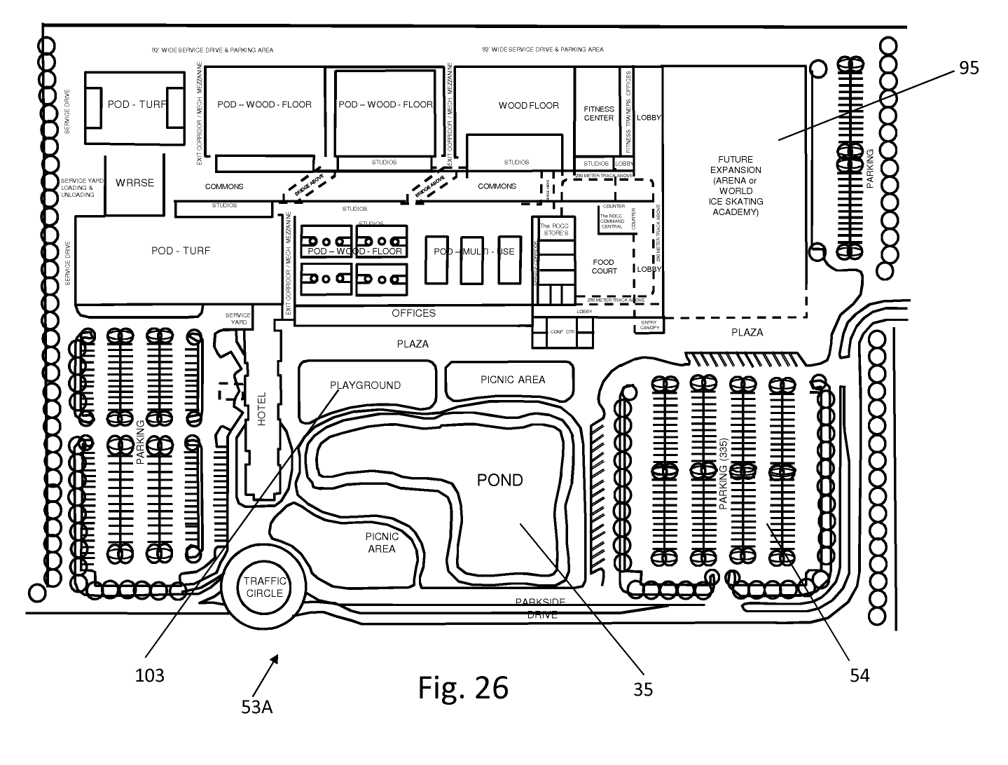

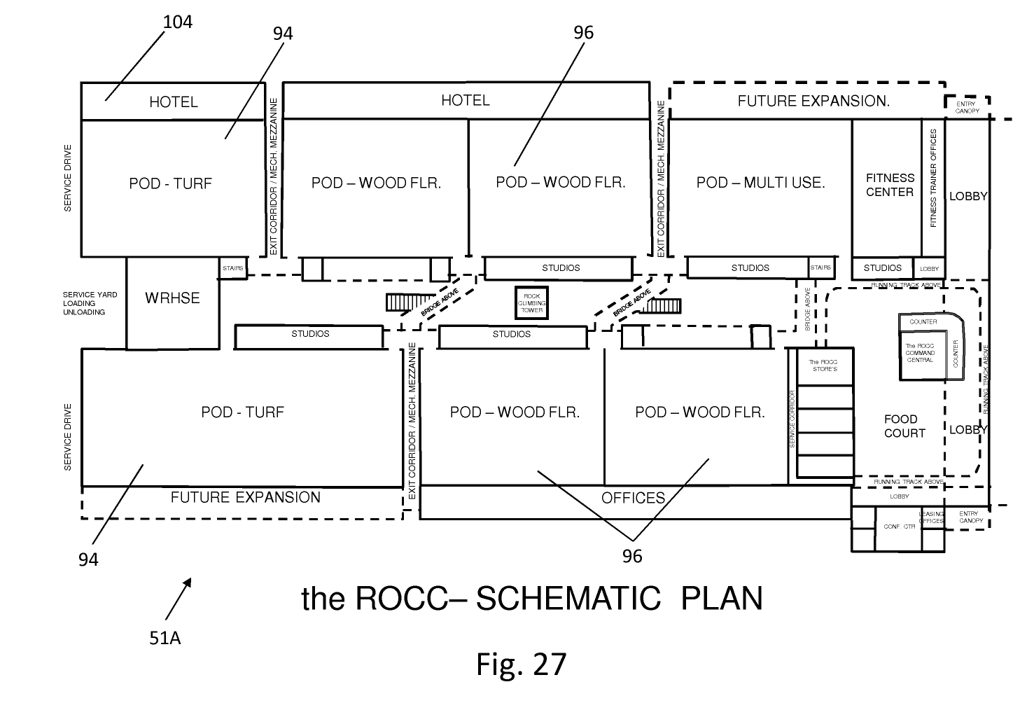

FIG. 26 is an alternative layout 53A of the full plot plan showing an optional skating rink 95 and expanded outdoor playgrounds 103 as another option. FIG. 27 is a layout of an optional complex 51A with turf fields 94, pods 59, hardwood floors 96 and multi-use floors in place as another option for the complex.

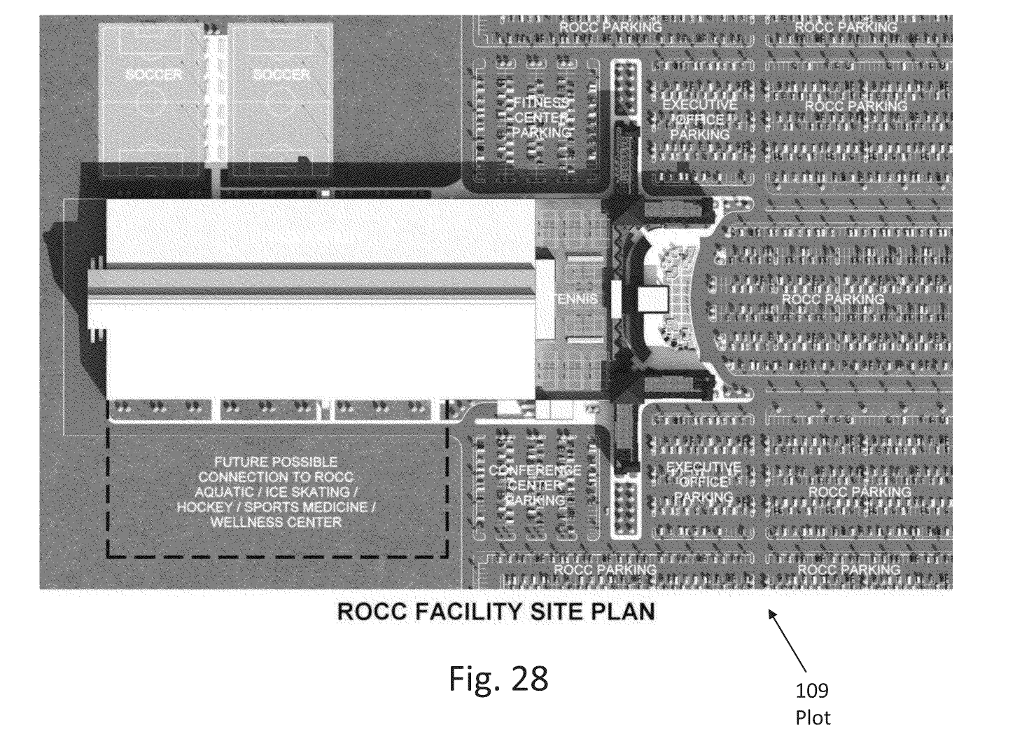

FIG. 28 is a plot plan 109 of another alternative building complex and surrounding parking lots and terrain for the flexible building complex 50 for a sporting complex. Its components are arranged as a different layout of the components listed and described above.

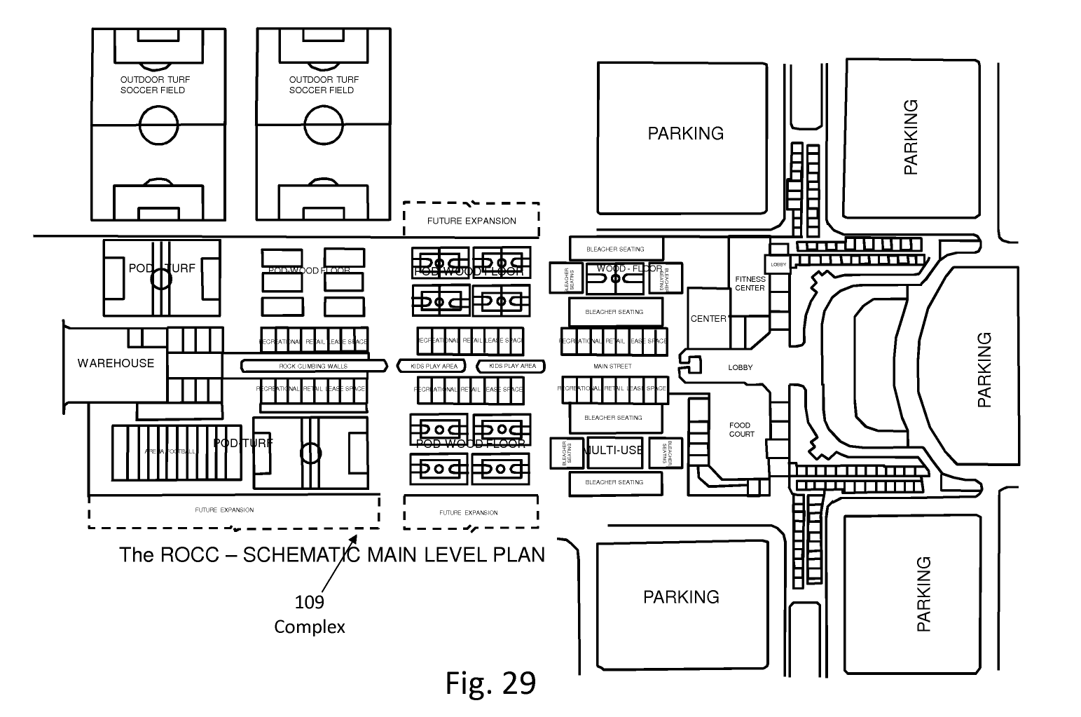

FIG. 29 is a layout 110 of the other plot and building plans for the other (second) alternative building complex for the ROCC. Its components are arranged as a different layout of the components listed and described above.

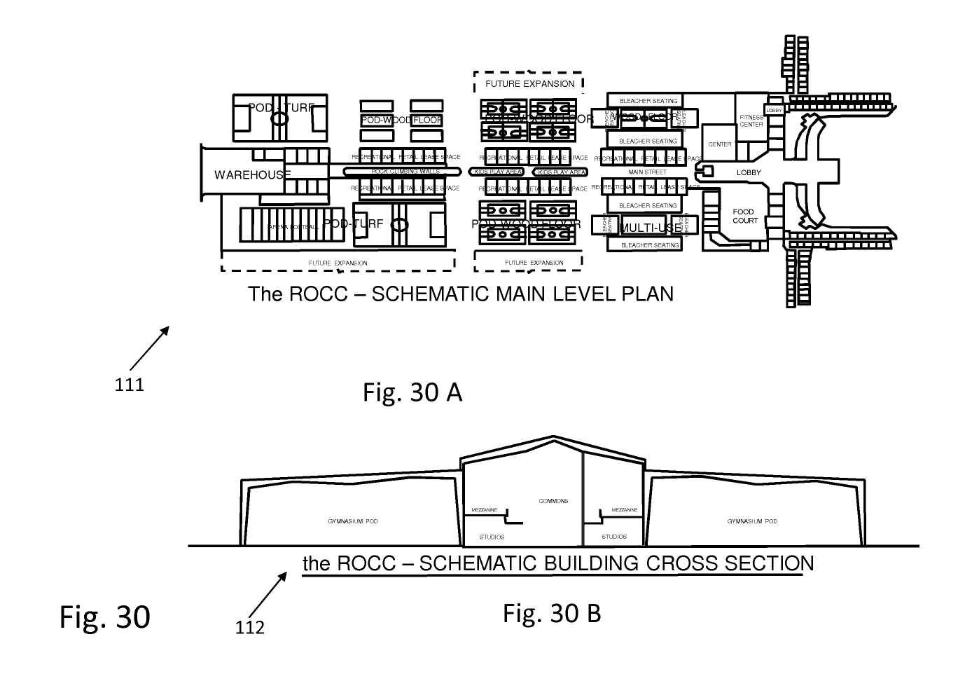

FIG. 30A is a schematic and layout 111 of the main level of an alternative building. FIG. 30 B is a schematic building cross-section/elevation 112 the alternative building 111.

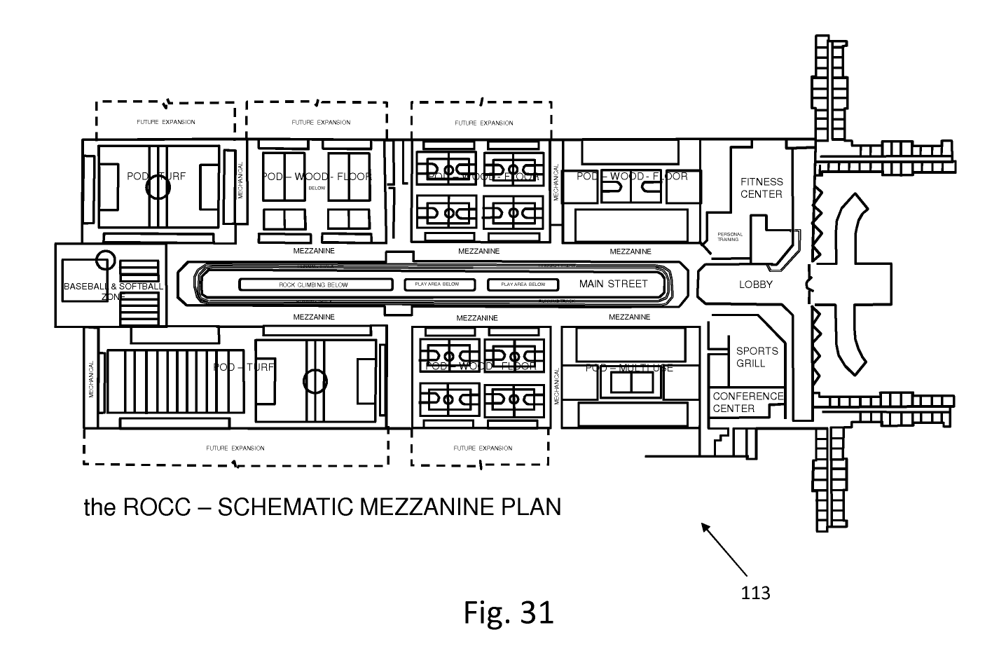

FIG. 31 is a schematic of the mezzanine level 113 of an alternative building complex for the ROCC.

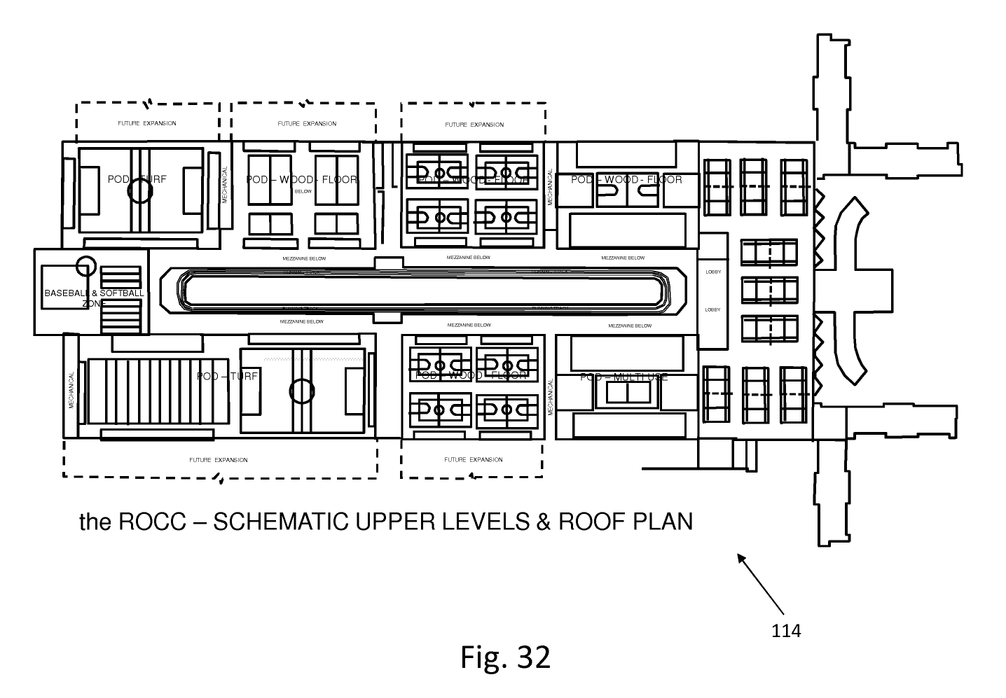

FIG. 32 is a schematic of the upper level and roof plan 114 of an alternative building complex for the ROCC.

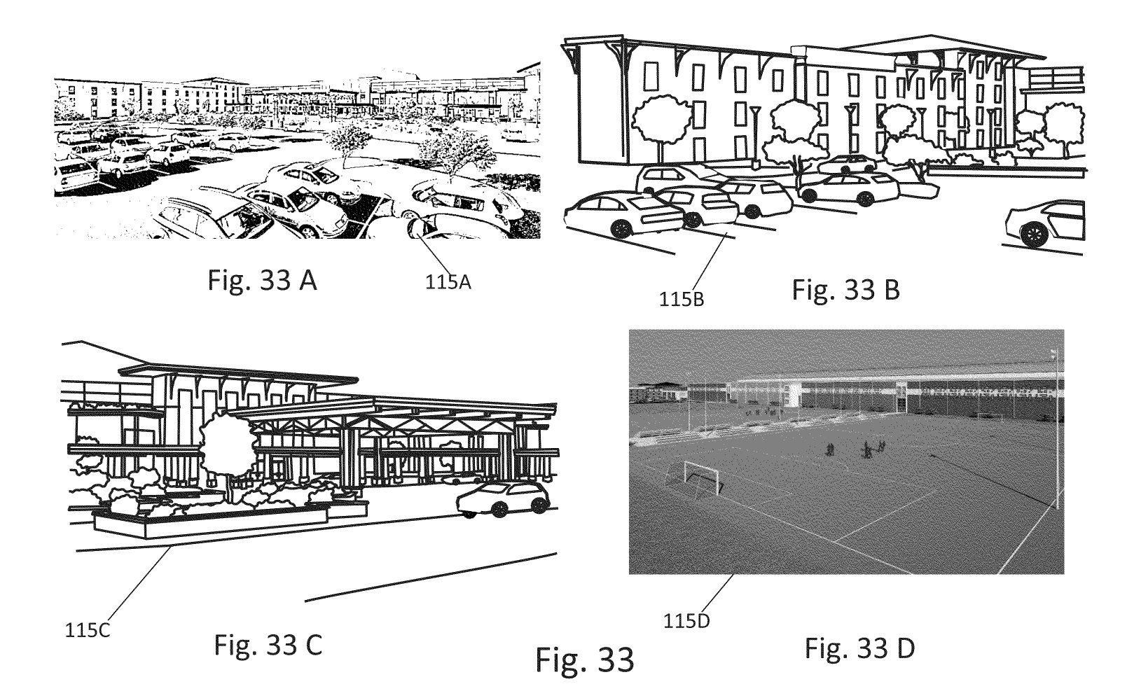

FIGS. 33 A through 33 D are renderings 115A, 115B, 115C, and 115D of the alternative building complex from several views.

The details mentioned here are exemplary and not limiting. Other specific components and manners specific to describing a Business Method Patent for determining the Financial Viability of Constructing a Recreation Center or a Flexible Commercial Center known as the ROCCS may be added as a person having ordinary skill in the financial methods field or the versatile building structures and their uses well appreciates.

### OPERATION OF THE PREFERRED EMBODIMENT

The Business Method Patent for determining the Financial Viability of Constructing a Recreation Center and a Flexible Commercial Center known as the ROCC have been described in the above embodiments. The manner of how this method and complex operate are described below. One notes well that the description above and the operation described here must be taken together to fully illustrate the concept of the Business Method Patent for determining the Financial Viability of Constructing a Recreation Center and a Flexible Commercial Center known as the ROCC.

The Business Method Patent for determining the Financial Viability of Constructing a Recreation Center is used and operates with some similarity to a decision matrix for other analysis involving the private sector and the public/governing bodies for a defined geographical area. However, the input of travel teams, concentrations of use, and all the side revenues are not normally contemplated with the building complex. Support must be first attained by communicating to a support group and the soliciting ideas and input. Next in this method 31 there is the finding and inclusion of accurate and real demographics (an example is shown in Appendix I) as to spending patterns, numbers of persons accompanying athletes and the duration of stay. This is then charted out as a flow diagram and the values of data input into the financial analysis. The overall business method 31 is shown in FIG. 2 and in the following Table:

### Selection and Financial Analysis For ROCC Recreational, Office, and Community Center

| Step | Item | Description |
|---|---|---|
| 1 | 31 | Select Geographical Area for Project Study |
| 2 | 32 | Determine Local Support and Governing Bodies |
| 3 | 33 | Select Cornerstone Sport |
| 4 | 34 | Obtain Local Demographics |
| 5 | 35 | Complete Financial Analysis & Project Options for |
| | | Scope |
| 6 | 36 | Select Scope & Original Size |
| 7 | 37 | Review & Communicate |
| 8 | 38 | Foster Public Awareness |
| 9 | 39 | Obtain Local Approval |
| 10 | 40 | Obtain Capital Financing |
| 11 | 41 | Build |
| 12 | 42 | Launch |
| 13 | 43 | Decide to Expand |

Examples of a subset spread sheet 35 are contained in Appendix III. The flowchart of this part of the Business Method of establishing the Financial viability of the Recreational Office and Convention Center (ROCC) is shown in FIG. 3 and the table below:

### Step 5. Complete Financial Analysis & Project Options for Scope

| Step | Item | Description |
|---|---|---|
| 5A. | 35A | Select Project Study |
| 5B. | 35B | Complete Income Analysis from Demographic |
| | | Indicators (4) - Executive Offices, Shops and |
| | | Studios, Hardwood Courts, Multiuse Floors, Turf |
| | | Fields, Conference Centers, Concessions, Event |
| | | Admissions, Community Pass, Advertising |
| 5C. | 35C | Calculate/Estimate Expenses |
| 5D. | 35D | Provide and Review Building Project Budget |
| 5E. | 35E | Complete Cash Flow Analysis |
| 5F. | 35F | Select Growth Options and Complete Aggressive and |
| | | Conservative Options |
| 5G. | 35F | Present Options to Support Group for Scope and |
| | | Size Selection |

With these descriptions of the method and the building structure it is to be understood that the Business Method Patent for determining the Financial Viability of Constructing a Recreation Center and the Flexible Commercial Center structure known as the ROCC are not to be limited to only the disclosed embodiments of the method and structure respectively. The features of the method and structure shown are intended to cover various modifications and equivalent arrangements included within the spirit and scope of the descriptions included herein with the written specification, the drawings and the appendices.

The included appendices that are showing the sample demographics, sample spending and income and the financial analyses spreadsheets are all fully incorporated by reference to this specification and accompanying drawings of the Business Method Patent for determining the Financial Viability of Constructing a Recreation Center and of the Flexible Commercial Center known as the ROCC.

### Appendix 1

Sports Impact

Impact
HamCo is the fifth largest sports market in the state as
measured by the number of events hosted and by visitor spending.
113 events representing 23 different sports were hosted in 2007
45,200 visitors traveled to HamCo County for a sporting event
in 2007
$5 million in direct spending by sports visitors.
Source: Certec Inc. and Indiana University Kelly School of
Business.
Visitor Spending
Average visitor spending pattern measures large travel events-
those events and tournaments hosting a significant number of
participants traveling in-bound and needing lodging.
Per Person Per Travel Party
Lodging $39.38 $144.74
Shopping/Retail/Fuel $34.12 $124.15
Restaurant $16.53 $60.24
Sports Event (on-site) $7.89 $28.90
Local Attractions $6.67 $24.21
Souvenirs $5.04 $18.30
Total $109.63 $400.54
Visitor Spending for smaller local events attracting a
significant number of local participants reaches $26.52 per
person/per day and $92.81 per travel party/per day.
Source: Certec Inc.
Trip Profiles
Conner Prairie, Indianapolis Museums, movies and aquatic
activities
54.73% dined in a restaurant while here
32.07% shopped while here
Mode of Transportation
Family Vehicle 75% School/Team Vehicle 4%
Fly 14% Chartered Bus 2%
Rental Car 9%
Source: Certec Inc. and Sports Research Partnerships.
Lodging Statistics
Average length of stay: 2.46 nights (national average 2.2)
Average travel party: 3.6 (national average 3.3)
15,067 room nights were tracked in 2007 for sporting events
68% of sports travelers prefer to stay in lodging properties
that provide a continental breakfast with their rate
Accommodation types chosen most often are (in order of
preference):
Hotel/Motel
Friend/Relative
Camping
Source: Certec Inc. and Sports Research Partnerships.
Projected Travel for 2009
More Trips 29%
Same Number of Trips 55%
Fewer Trips 16%

Sources (1) “Daily Expenditures of Attendees at Sports Events in HamCo - 2008,” prepared for the HamCo Convention and Visitors Bureau, Inc. by Certec Inc. (2) “The Economic Impact of Amateur Sports Tourism in Indiana,” prepared for Sports Indiana by Indiana University Kelly School of Business (3) and “2009 NASC Amateur Sports Event Study,” prepared for National Association of Sports Commissions by Sports Research Partnerships.

Tourism Impact

HamCo Indiana Tourism Statistics Economic Impact
HamCo is the third largest tourism destination market in Indiana
behind Indianapolis and Lake County as measured by economic impact.
Tourism accounts for $263.7 million in direct expenditures by
visitors each year. (reflects a 3.1% annual growth rate 2007-2009
when adjusted for inflation)
Food and Beverage expenditures account for $75.2 million, Lodging
expenditures account for $64.6 million, and Shopping expenditures
account for $50.9 million of the total.
Lodging guests spend $116 million or $136 per person per day.
Guests visiting friends and relatives spend $56.2 million or $63 per
person per day. Visitors passing through for the day spend $50.6
million or $30 per person per day. Visitors coming to the
attractions spend $39.3 million or $45 per person per day. Visitors
staying at campgrounds spend $1.6 million or $62 per person per day.
$16.8 million in local tax revenues are generated as a result of
tourism here, or a contribution of $162 per county household.
$31.2 million in state tax revenues are generated as a result of
tourism here.
More than 5,100 jobs in the county are directly or indirectly
related to the tour and travel industry.
Visitor Profiles
Destination travelers to the county totaled nearly 2 million
persons in 2009 compared to 1.8 million in 2007. (reflects a growth
rate of 9.2%)
Pass-through travelers to the county totaled 1.6 million persons.
Origination of visitors: primarily surrounding states
Education level: 75% are college graduates or have completed post-
graduate studies
Average age: 48
Household: 24% have kids living at home
Status: 70% are married; 30% are single
Income: 72% have incomes of more than $50,000; 47% of those have
incomes of more than $70,000.00
Job: 53% are professionals
Trip Profiles
Average travel party: 3.2 people
Trip type: 50% are on a short trip (1-3 nights); 17.5% are day-
trip visitors; 90% of overnight visitors stay in hotels while here;
51.6% are on their first visit here
Trip planning: 67.5% used the Internet to make travel plans; 43.2%
relied on friends or relatives.
Most popular months visited: May 25%, June 25%, July 25%, August
16%, and September 14%
Most mentioned activities: Dining out, Shopping, Verizon Wireless
Music Center, Vineyard/Brewpub, Downtown Noblesville, Sporting
tournament, Conner Prairie, Indiana Transportation Museum, Carmel
Arts & Design District, Trails, Golf
Sources: “Economic Impact of HamCo Tourism and Travel Industry
2009, prepared for the HamCo Convention and Visitors Bureau Inc. by
Certec, Inc.; Strategic Marketing & Research, Inc., 2010;
D. K. Shifflet Assoc. Revised December 2010.

Appendix 2

Information and Sources for Costs & Pricing

BASKETBALL
S.P.O.R.T.s meeting On May 14, 2010;
$15/child utility fee to schools for rec (2 hours/week for 10 weeks)
$25-$30/child utility fee to schools for travel teams Use 6-8
courts from October through April - S.P.O.R.T.s. Basketball
estimates from Lynda C on Jun. 07, 2010;
Boys Rec:
78 teams @ 1 hour each for 14 weeks
17 teams @ 1.5 hours each for 14 weeks
95 teams @ 1 hour each Saturday games for 11 weeks
Boys Tournament:
Girls Rec:
First week one hour practice for all teams (95 hrs)
1st Saturday: 50 hours gym space for games
Second week one hour practice for teams left (20 hrs)
Second Saturday games: 25 hours
38 teams @1 hour each for 14 weeks
38 teams @ 1 hour each Saturday games for 10 weeks
Girls Tournament:
½ league only practiced one hour and got award
10 teams = 5 hours (shared court)
3rd grade: reed one hour practice share court
8 teams = 4 hours
Saturday tournament hours: 7
4-6th grade: tournament started during week
20 teams = 8 hours (4 teams got bye)
Saturday tournament hours: 7
* * Remember: all teams share an hour--½ court practices
Sports of All Sorts, Indiana: Full Size Basketball Court @ $50/hour
The Sport Zone, Indianapolis rolls listed on website November 2010@
www.sportzoneindv.com
Full Size Basketball court @$90/hr Half-Court Basketball @$70/hr
Falcon Parle Recreation Center, It rates listed on website JJ/20JO@
www.palotineoorks.org
Rates varied for Resident or Non-Resident, Prime Time, or Season:
Full Size Basketball court @ $72-$165/hour
Half Court Basketball @ $44-$105/hour
VOLLEYBALL
S.P.O.R.T.S meeting on May 14, 2010:
$15/child utility fee to schools for rec (2 hours/week for 10 weeks)
$25-$30/child utility fee to schools for travel teams
Use 6-8 courts from October through April
Magnum Volleyball Club meeting on May 19, 2010:
Club season runs November through June (plus year round camps and training)
Usage is 5:00 pm to 10:30 pm weekdays, 8:00 am to 5:00 pm Saturdays
Previously paid rates—$40/hour per court (Boys/Girls club)
$50-$60/hour per court: (Field House)
S.P.O.R.T.S. Volleyball estimates from Barb Tease:
Season runs from August 14-October 16
Monday-Thursday practices 30 hours/week
Saturday Games—3 courts for 6 hours each
Tournament—7 to 9 courts throughout the day
TURF FIELD
The SportZone, Indianapolis rotes listed on website November 2010@
www.sDrotzoneindv.com Soccer Field: 185 × 85 feet @ $185/hour
Baseball Field Areas:
120 × 120 feet @ $250/hour 120 × 75 feet @ $200/hour
120 × 95 feet @ $375/hour (both areas)
Sports of All Sorts, Indianapolis:
Full Turf Field:
90 × 120 feet @ $160/hour
Half-Turf Field: 90 × 60 feet@ $80/hour
CFC Arena, Hamden, cr rates listed on website 11/Z010@
http://dcarena.comlslte
Turf Field Rental Rates:
FIELD 1: 195 × 105 feet@ $195/hour (OCTOBER-MARCH) @$120/hour (APRIL-SEPTEMBER)
FIELD 2: 195 × 105 feet @ $195/hour (OCTOBER-MARCH) @ $120/hour (APRIL-SEPTEMBER)
FIELD 3: 105 × 45 feet @ $50/hour
Soccer Blast, MN rates listed on website November 2010 at
www.soccerblastmn.com Half-Dome-l field: 150 × 100 feet @$80-$150/hr
Full Dome (2 fields): 150 × 200 feet @ $160• $300/hour
Boarded Field: 85 × 185 feet @ $80• $150/hour
Falcon Park Recreation Center, IL rates listed on website November 2010 at
www.oalarineparks.org
Rates varied for Resident or Non-Resident, Prime Time, or Season:
90 × 180 feet @ $68. $210/hour 90 × 90 feet@$40-$10S/hour
FUTSAL
DB - Soccer Consultants Inc. FutsalTeam fees @ $425-$650 Iteam
Field rental rates @ $150/hour
DK: U12 Turf rental @ $250/hour
LACROSSE
BR - Boys Lacrosse (S.P.O.R.T.S.):
Indoor Off-Season training -1 night/week for 1.5 hours (6 weeks)
with 100 3″•8′″ graders
$72.50/hour per K field (6 weeks = $1,000 total)
Indy Indoor Lacrosse (OTW, Carmel)-
7th• 8th grade• 13 per team × 2 teams × 2 sessions• 52 players × $75 =
$3,900. (1 hour games × 8 games = 16 hours per field per team)
5th• 6th grade• 13 per team × 2 teams × 2 sessions - 52 players ×
$75 = $3,900 (1 hour games × 8 games~16 hours per field per team)
HOCKEY
JM - Muskegon Lumberjacks:
40 at home games per season
3,800 spectators @ $12 ticket ($1,800,000 annual gross)
$4.75/spectator average for Concession Spending ($720,000 annual
gross)
BATTING CAGES
Falcon Parle Recreation Center, IL rotes listed on website November 2010 @
www.palatineporles.org
Rates varied for Resident or Non-Resident, Prime Time, or Season:
MEMBERSHIP
Per cage for 55 minutes @ $28-$45
Per cage for 30 minutes @ $14-$23
Sports Of All Sorts, IN rotes listed on flyer January 2011
24 hour Access to Fitness Center, Group Classes, “Walk-On” Court
Use, Free Gate Admissions:
Individual @ $19.99/month ($60 Enrollment)
Couple @ $29.99/month ($90 Enrollment)
Family@ $39.99/month ($120 Enrollment)
Centennial Sportsplex, TN rotes listed on website November 2010@
www.nashville.qov/sportsplex
Access to Fitness Center, Weight Room, Classes, Open and Lap Swim,
Public Skating, Outdoor Tennis Courts:
ADVERTISING
Individual @ $484/year (Resident)
Spouse/Dependent Age 16 up @ $220/year (Resident)
Dependent Age 5-15 @ $132/year (Resident)
Seniors/College/Military @ $330/year (Resident)
Individual @ $532/year (Resident)
Spouse/Dependent Age 16 up @ $242/year (Resident)
Dependent Age 5-15 @ $132/year (Resident)
Seniors/College/Military @ $363/year (Resident)
Indianapolis Sports Parle rates listed on website January 2011 @
www.indvsportpark.com
10′ × 7′ sign/11′ × 5′ billboard @ $1000/year
McCook Athlete & Exposition Center (the MAX), Chicago, IL rotes
listed on website February 2011 @ www.mox-mccook.com
5′ × 10′ banner @ $1000/year
10′ × 10′ banner @ $2400/year
10′ × 15′ banner@ $3500/year
10′ × 20′ banner @ $4200/year
Annual Sponsor-10′ × 20′ banner plus booth at 4 events @ $5000/year
Event Sponsor - Event booth, display, logo on promo event materials
@ $2500/event
CONVENTION & CONFERENCE
HamCo Fairgrounds rates listed on website 04/20JO ~
http://hamiltoncofarigrounds.com
16,000 sf. Exhibition hall @ $990/day
4,300 sf. Exhibition hall @ $410/day
Commercial Kitchen @ $23S/day10′ × 7′ sign/11′ × 5′ billboard @
$1000/year

### Appendix 3

Business Valuation

| | Very | | | |
|---|---|---|---|---|
| | Conservative | Conservative | Moderate | *Gross |
| Potential Income | $3,519,357 | $5,969,643 | $8,877,338 | $18,855,014 |
| Business | | | | |
| Valuation | | | | |
| Labor Expense | $1,782,040 | $1,782,040 | $1,782,040 | $1,782,040 |
| Operating | $1,459,500 | $1,459,500 | $1,459,500 | $1,459,500 |
| Expense | | | | |
| Total Expense | $3,241,540 | $3,241,540 | $3,241,540 | $3,241,540 |
| Stabilized Gross | $277,817 | $2,728,103 | $5,635,798 | $15,613,474 |
| Profit | | | | |
| Market Value | | | | |
| Cap Rate: | 8% | 8% | 8% | 8% |
| | $3,472,722 | $34,101,290 | $70,447,482 | $195,168,425 |
| Cap Rate: | 10% | 10% | 10% | 10% |
| | $2,778,178 | $27,281,032 | $56,357,986 | $156,134,740 |
| Cap Rate: | 15% | 15% | 15% | 15% |
| | $1,852,118 | $18,187,354 | $37,571,990 | $104,089,826 |
| Projected | $38,580,000 | $38,580,000 | $38,580,000 | $38,580,000 |
| Building Cost | | | | |
| Investment Yield | 0.72% | 7.07% | 14.61% | 40.47% |

Projected Income

| | | INCOME | | | | | | |
|---|---|---|---|---|---|---|---|---|
| | | Very | | INCOME | | INCOME | | INCOME |
| | | Conservative | | Conservative | | Moderate | | *Gross |
| | Occup | | Occup | | Occup | | Occup | |
| Executive | 70% | $616,493 | 80% | $704,563 | 90% | $792,634 | 100% | $880,704 |
| Offices | | | | | | | | |
| Shops & | 70% | $574,875 | 80% | $657,000 | 90% | $739,125 | 100% | $821,250 |
| Studios | | | | | | | | |
| | HR/WK | | HR/WK | | HR/WK | | HR/WK | |
| Hardwood | 13.00 | $865,280 | 26.00 | $1730560 | 39.00 | $2595840 | 119.00 | $7471360 |
| Courts | | | | | | | | |
| Multi-Use | 10.50 | $56,160 | 21.00 | $112,320 | 42.00 | $224,640 | 119.00 | $616200 |
| Courts | | | | | | | | |
| Turf Fields | 13.00 | $507,000 | 26.00 | $1014000 | 39.00 | $1521000 | 119.00 | $4641000 |
| | Days/YR | | Days/YR | | Days/YR | | Days/YR | |
| Conference | 25 | $27,500 | 50 | $55,000 | 75 | $82,500 | 100 | $110,000 |
| Center | | | | | | | | |
| | Patrons @ | | Patrons | | Patrons | | Patrons | |
| | $5 yr | | @ $5 yr | | @ $5 yr | | @ $5 yr | |
| Concessions | 75000 | $251250 | 150000 | $502,500 | 300000 | $1005000 | 500000 | $1675000 |
| | Admis | | Admis | | Admis | | Admis | |
| | @$3 ea | | @$3 ea | | @$3 ea | | @$3 ea | |
| Event | 50000 | $150,000 | 100000 | $300,000 | 200000 | $600,000 | 300000 | $900,000 |
| Admission | | | | | | | | |
| | Fam | | Fam | | Fam | | Fam | |
| | @$75 | | @$75 | | @$75 | | @$75 | |
| Community | 5000 | $375000 | 10,000 | $750000 | 15000 | $1125000 | 20000 | $1,500,000 |
| Pass | | | | | | | | |
| Advertising | 40% | $95,800 | 60% | $143,700 | 80% | $191,600 | 100% | $239,500 |
| Income | | $3519358 | | $5969643 | | $8877339 | | $18855014 |

Income Table Notes:

| Item | Area | Rates |
|---|---|---|
| 1 | Executive | $28 to $32 sf. rental rates |
| | Offices | |
| 2 | Shops & Studios | $10 to $25 sf. rental rates |
| 3 | Hardwood Courts | $70-$80/hour per full size basketball |
| | | court (1/4 Pod) |
| 4 | Multi-Use | $25-$40/hour per tennis, basketball, or |
| | Courts | volleyball court (1/3 Pod) |
| 5 | Turf Fields | $150/hour per field (75′ × 120′) |
| 6 | Conference | Based on daily rental costs |
| | Center | |
| 7 | Concessions | Assuming $5 expenditure minus 33% costs of |
| | | goods |
| 8 | Advertising | Sponsorships and Banner Advertising for |
| | | Facility, Courts, Fields, Etc. |
| 9 | *Gross Income | Figured using 100% occupancy for offices, |
| | | shops, and studios; and 17 hour day for |
| | | courts and fields |

All other Income areas could potentially be increased

Projected Expenses

| Item | Expenses | Annual |
|---|---|---|
| 1 | Labor, Payroll Tax, Insurance | $1,782,040 |
| 2 | Repairs and Maintenance | $141,000 |
| 3 | Computers & Website | $41,000 |
| 4 | Supplies | $31,000 |
| 5 | Postage & Delivery | $15,000 |
| 6 | Telephone | $20,000 |
| 7 | Professional Services | $90,000 |
| 8 | Advertising | $92,000 |
| 9 | Insurance | $150,000 |
| 0 | Utilities | $702,000 |
| 11 | Other | $27,500 |
| 13 | Property Taxes (abated) | $— |
| 14 | Contingencies Fund | $150,000 |
| 15 | Total Expense | $3,241,540 |

Labor Expenses

| | | | Days | Wks/ | | | Annual |
|---|---|---|---|---|---|---|---|
| | | Total Hrs. | Per | Yr | Wks/ | | Pay |
| | Position | Per Day | Week | Year | Yr | Pay Rate | Year |
| 1 | Facility Manager/ | 8 | 5 | 52 | 35 | $72,800 | 2080 |
| | Director | | | | | | |
| 2 | Business Manager/ | 8 | 5 | 52 | 30 | $62,400 | 2080 |
| | Financial | | | | | | |
| 3 | Assistant Manager/ | 8 | 5 | 52 | 28 | $58,240 | 2080 |
| | Personnel | | | | | | |
| 4 | Office Assistant/ | 8 | 5 | 52 | 18 | $37,440 | 2080 |
| | Leasing Agent | | | | | | |
| 5 | Maintenance Day | 8 | 7 | 52 | 15 | $43,680 | 2912 |
| 6 | Maintenance Day 2 | 8 | 7 | 52 | 15 | $43,680 | 2912 |
| 7 | House Keeping | 16 | 7 | 52 | 12 | $69,888 | 5824 |
| 8 | House Keeping 2 | 16 | 7 | 52 | 12 | $69,888 | 5824 |
| 9 | House Keeping 3 | 16 | 7 | 52 | 12 | $69,888 | 5824 |
| 10 | Security | 24 | 7 | 52 | 20 | $174,720 | 8736 |
| 11 | Security 2 | 24 | 7 | 52 | 20 | $174,720 | 8736 |
| 12 | EMT | 16 | 7 | 52 | 22 | $128,128 | 5824 |
| 13 | IT Tech./ | 8 | 5 | 52 | 25 | $52,000 | 2080 |
| | Website/Security | | | | | | |
| 14 | Marketing/Event | 8 | 5 | 52 | 25 | $52,000 | 2080 |
| | Coordinator | | | | | | |
| 15 | Assistant/Scheduling | 8 | 5 | 52 | 20 | $41,600 | 2080 |
| 16 | ROCC Shop/Concessions | 8 | 7 | 52 | 15 | $43,680 | 2912 |
| 17 | ROCC Shop/Concessions2 | 8 | 7 | 52 | 15 | $43,680 | 2912 |
| 18 | Sports Counter Weekdays | 16 | 5 | 52 | 15 | $62,400 | 4160 |
| 19 | Sports Counter Weekends | 16 | 2 | 52 | 15 | $24,960 | 1664 |
| 20 | Sports Counter Weekends2 | 16 | 2 | 52 | 15 | $24,960 | 1664 |
| 21 | Event Staff Concessions | 8 | 2 | 52 | 10 | $8,320 | 832 |
| 22 | Event Staff Concessions2 | 8 | 2 | 52 | 10 | $8,320 | 832 |
| 23 | Event Staff Concessions3 | 8 | 2 | 52 | 10 | $8,320 | 832 |
| 24 | Event Staff Doors | 8 | 2 | 52 | 10 | $8,320 | 832 |
| 25 | Event Staff Doors 2 | 8 | 2 | 52 | 10 | $8,320 | 832 |
| 26 | Event Staff Doors 3 | 8 | 2 | 52 | 10 | $8,320 | 832 |
| 27 | Event Staff Extra | 8 | 2 | 52 | 10 | $8,320 | 832 |
| 28 | Event Staff Extra 2 | 8 | 2 | 52 | 10 | $8,320 | 832 |
| 29 | Event Staff Extra 3 | 8 | 2 | 52 | 10 | $8,320 | 832 |

| | | |
|---|---|---|
| 30 | Labor Expense | $1,425,632 |
| 31 | Payroll Tax & WC | $213,845 |
| 32 | Health Insurance | $142,563 |
| 33 | Total Labor | $1,782,040 |

Operating Expense

| Item | Estimated Expenses | Annual |
|---|---|---|
| 1 | Automobiles and Fuel | $12,500 |
| 2 | Building Maint/ | $51,000 |
| | Repairs | |
| 3 | Lawn Care/ | $30,000 |
| | Landscaping | |
| 4 | Equipment Repairs | $60,000 |
| 5 | Website Hosting | $10,000 |
| 6 | Online Scheduling | $6,000 |
| | Software | |
| 7 | Computer Service | $10,000 |
| 8 | Hardware & Software | $15,000 |
| 9 | Maintenance Supplies | $9,000 |
| 10 | Office Supplies | $22,000 |
| 11 | Postage & Delivery | $15,000 |
| 12 | Telephone | $20,000 |
| 13 | Legal | $50,000 |
| 14 | Accounting | $40,000 |
| 15 | Travel & | $10,000 |
| | Entertainment | |
| 16 | Advertising | $70,000 |
| 17 | Uniforms | $12,000 |
| 18 | Insurance | $150,000 |
| 19 | Cable Service | $15,000 |
| 20 | Dumpster Service | $12,000 |
| 21 | Water & Sewer | $75,000 |
| 22 | Gas & Electric | $600,000 |
| 23 | Storm water | $15,000 |
| 24 | Property Taxes | $0 |
| 25 | Contingencies Fund | $150,000 |
| 26 | Operating Expense | $1,459,500 |

Executive Offices

| | | | | | | All | | | | |
|---|---|---|---|---|---|---|---|---|---|---|
| | | | | | | Units | Price | Price | Monthly | Annual |
| Unit | # of | | Size | | Size | Total | Per | Per | All | All |
| Description | Units | L′ | x | W′ | Sf. | Sf. | Sf. | Yr/U | Units | Units |
| 1st Floor | 16 | 9 | x | 12 | 108 | 1728 | $32 | $3,456 | $4,608 | $55,296 |
| Interior | | | | | | | | | | |
| 1st Floor | 24 | 12 | x | 15 | 180 | 4320 | $30 | $5,400 | $10,800 | $129,600 |
| Exterior | | | | | | | | | | |
| 1st Floor | 6 | 14 | x | 15 | 210 | 1260 | $28 | $5,880 | $2,940 | $35,280 |
| Exterior | | | | | | | | | | |
| 2nd Floor | 16 | 9 | x | 12 | 108 | 1728 | $32 | $3,456 | $4,608 | $55,296 |
| Interior | | | | | | | | | | |
| 2nd Floor | 24 | 12 | x | 15 | 180 | 4320 | $30 | $5,400 | $10,800 | $129,600 |
| Exterior | | | | | | | | | | |
| 2nd Floor | 6 | 14 | x | 15 | 210 | 1260 | $28 | $5,880 | $2,940 | $35,280 |
| Exterior | | | | | | | | | | |
| 3rd Floor | 16 | 9 | x | 12 | 108 | 1728 | $32 | $3,456 | $4,608 | $55,296 |
| Interior | | | | | | | | | | |
| 3rd Floor | 24 | 12 | x | 15 | 180 | 4320 | $30 | $5,400 | $10,800 | $129,600 |
| Exterior | | | | | | | | | | |
| 3rd Floor | 6 | 14 | x | 15 | 210 | 1260 | $28 | $5,880 | $2,940 | $35,280 |
| Exterior | | | | | | | | | | |
| 4th Floor | 16 | 9 | x | 12 | 108 | 1728 | $32 | $3,456 | $4,608 | $55,296 |
| Interior | | | | | | | | | | |
| 4th Floor | 24 | 12 | x | 15 | 180 | 4320 | $30 | $5,400 | $10,800 | $129,600 |
| Exterior | | | | | | | | | | |
| 4th Floor | 6 | 14 | x | 15 | 210 | 1260 | $28 | $5,880 | $2,940 | $35,280 |
| Exterior | | | | | | | | | | |
| TOTAL | 184 | | | | | 14616 | | | $73,392 | $880,704 |

| | | |
|---|---|---|
| Occupancy | 70% | $616,493 |
| Occupancy | 80% | $704,563 |
| Occupancy | 90% | $792,634 |
| Occupancy | 100% | $880,704 |

Shops and Studios

| | | | | | | | Price | | |
|---|---|---|---|---|---|---|---|---|---|
| | | | | | Size | Total | Per | Monthly | Annual |
| Unit | # of | | Size | | Sq. | Sq. | Sq. | All | All |
| Description | Units | L′ | | W′ | Ft. | Ft. | Ft. | Units | Units |
| Studios | 1 | 25 | x | 160 | 4000 | 4000 | $10 | $3,333 | $40,000 |
| Studios | 1 | 25 | x | 160 | 4000 | 4000 | $10 | $3,333 | $40,000 |
| Studios | 1 | 25 | x | 160 | 4000 | 4000 | $10 | $3,333 | $40,000 |
| Studios | 1 | 25 | x | 160 | 4000 | 4000 | $10 | $3,333 | $40,000 |
| Studios | 1 | 25 | x | 65 | 1625 | 1625 | $10 | $1,354 | $16,250 |
| Fitness | 1 | 75 | x | 150 | 11250 | 11250 | $20 | $18,750 | $225,000 |
| Center 1st | | | | | | | | | |
| Floor | | | | | | | | | |
| Fitness | 1 | 75 | x | 150 | 11250 | 11250 | $15 | $14,063 | $168,750 |
| Center 2nd | | | | | | | | | |
| Floor | | | | | | | | | |
| Trainer | 15 | 10 | x | 20 | 200 | 3000 | $20 | $5,000 | $60,000 |
| Offices | | | | | | | | | |
| Food Court | 5 | 23 | x | 60 | 1380 | 6900 | $25 | $14,375 | $172,500 |
| Shops | | | | | | | | | |
| Food Court | 1 | 25 | x | 30 | 750 | 750 | $25 | $1,563 | $18,750 |
| Shops | | | | | | | | | |
| Total | 28 | | | | | 50775 | | $68,438 | $821,250 |

| | | | |
|---|---|---|---|
| Occupancy | 70% | $574,875 | Annual Total |
| Occupancy | 80% | $657,000 | Annual Total |
| Occupancy | 90% | $739,125 | Annual Total |
| Occupancy | 100% | $821,250 | Annual Total |

Hardwood Courts

| | | # | Rate/ | Pot'l | Est. | Hrs | Gross | Est. | Hrs | Gross | Est. | Hrs | Gross |
|---|---|---|---|---|---|---|---|---|---|---|---|---|---|
| | | Hr | Hr. | Rev | Usage | Used | Rev | Usage | Used | Rev | Usage | Used | Rev |
| Mon | 7:a-3 | 8 | $70 | $560 | 0% | 0 | $0 | 0% | 0 | $0 | 100% | 8 | $560 |
| | 3:p10 | 7 | $80 | $560 | 20% | 1.4 | $112 | 60% | 4.2 | $336 | 100% | 7 | $560 |
| | 10-12 | 2 | $70 | $140 | 0% | 0 | $0 | 0% | 0 | $0 | 100% | 2 | $140 |
| | 12-7a | 7 | $70 | $490 | 0% | 0 | $0 | 0% | 0 | $0 | 0% | 0 | $0 |
| Tues | 7:a-3 | 8 | $70 | $560 | 0% | 0 | $0 | 0% | 0 | $0 | 100% | 8 | $560 |
| | 3:p10 | 7 | $80 | $560 | 20% | 1.4 | $112 | 60% | 4.2 | $336 | 100% | 7 | $560 |
| | 10-12 | 2 | $70 | $140 | 0% | 0 | $0 | 0% | 0 | $0 | 100% | 2 | $140 |
| | 12-7a | 7 | $70 | $490 | 0% | 0 | $0 | 0% | 0 | $0 | 0% | 0 | $0 |
| Wed | 7:a-3 | 8 | $70 | $560 | 0% | 0 | $0 | 0% | 0 | $0 | 100% | 8 | $560 |
| | 3:p10 | 7 | $80 | $560 | 20% | 1.4 | $112 | 60% | 4.2 | $336 | 100% | 7 | $560 |
| | 10-12 | 2 | $70 | $140 | 0% | 0 | $0 | 0% | 0 | $0 | 100% | 2 | $140 |
| | 12-7a | 7 | $70 | $490 | 0% | 0 | $0 | 0% | 0 | $0 | 0% | 0 | $0 |
| Thurs | 7:a-3 | 8 | $70 | $560 | 0% | 0 | $0 | 0% | 0 | $0 | 100% | 8 | $560 |
| | 3:p10 | 7 | $80 | $560 | 20% | 1.4 | $112 | 60% | 4.2 | $336 | 100% | 7 | $560 |
| | 10-12 | 2 | $70 | $140 | 0% | 0 | $0 | 0% | 0 | $0 | 100% | 2 | $140 |
| | 12-7a | 7 | $70 | $490 | 0% | 0 | $0 | 0% | 0 | $0 | 0% | 0 | $0 |
| Fri | 7:a-3 | 8 | $70 | $560 | 0% | 0 | $0 | 0% | 0 | $0 | 100% | 8 | $560 |
| | 3:p10 | 7 | $80 | $560 | 20% | 1.4 | $112 | 60% | 4.2 | $336 | 100% | 7 | $560 |
| | 10-12 | 2 | $70 | $140 | 0% | 0 | $0 | 0% | 0 | $0 | 100% | 2 | $140 |
| | 12-7a | 7 | $70 | $490 | 0% | 0 | $0 | 0% | 0 | $0 | 0% | 0 | $0 |
| Sat | 7:a-3 | 11 | $80 | $880 | 20% | 2.2 | $176 | 60% | 6.6 | $528 | 100% | 11 | $880 |
| | 3:p10 | 4 | $80 | $320 | 20% | 0.8 | $64 | 60% | 2.4 | $192 | 100% | 4 | $320 |
| | 10-12 | 2 | $70 | $140 | 0% | 0 | $0 | 0% | 0 | $0 | 100% | 2 | $140 |
| | 12-7a | 7 | $70 | $490 | 0% | 0 | $0 | 0% | 0 | $0 | 0% | 0 | $0 |
| Sun | 7:a-3 | 11 | $80 | $880 | 20% | 2.2 | $176 | 60% | 6.6 | $528 | 100% | 11 | $880 |
| | 3:p10 | 4 | $80 | $320 | 20% | 0.8 | $64 | 60% | 2.4 | $192 | 100% | 4 | $320 |
| | 10-12 | 2 | $70 | $140 | 0% | 0 | $0 | 0% | 0 | $0 | 100% | 2 | $140 |
| | 12-7a | 7 | $70 | $490 | 0% | 0 | $0 | 0% | 0 | $0 | 0% | 0 | $0 |

| | | | | |
|---|---|---|---|---|
| Hrs/wk | 13 | 26 | 39 | 119 |
| Wkly Gross/ | $1,040 | $ 2,080 | $3,120 | $8,980 |
| Court | | | | |
| # of Courts | 16 | 16 | 16 | 16 |
| Wkly Gross | $16,640 | $33,280 | $49,920 | $143,680 |
| All Courts | | | | |
| Annual Income | $865,280 | $1,730,560 | $2,595,840 | $7,471,360 |

Multi-Use Courts

| | | # | Rate/ | Pot'l | Est. | Hrs | Gross | Est. | Hrs | Gross | Est. | Hrs | Gross |
|---|---|---|---|---|---|---|---|---|---|---|---|---|---|
| | Time | hrs | Hr | REV | Usage | Used | REV | Usage | Used | REV | Usage | Used | REV |
| Mon | 7:a-3 | 8 | $25 | $200 | 20% | 1.6 | $40 | 40% | 3.2 | $80 | 100% | 8 | $200 |
| | 3:p-10 | 7 | $40 | $280 | 20% | 1.4 | $56 | 40% | 2.8 | $112 | 100% | 7 | $280 |
| | 10-12 | 2 | $25 | $50 | 0% | 0 | $— | 0% | 0 | $— | 100% | 2 | $50 |
| | 12-7a | 7 | $25 | $175 | 0% | 0 | $— | 0% | 0 | $— | 0% | 0 | $— |
| Tues | 7:a-3 | 8 | $25 | $200 | 20% | 1.6 | $40 | 40% | 3.2 | $80 | 100% | 8 | $200 |
| | 3:p-10 | 7 | $40 | $280 | 20% | 1.4 | $56 | 40% | 2.8 | $112 | 100% | 7 | $280 |
| | 10-12 | 2 | $25 | $50 | 0% | 0 | $— | 0% | 0 | $— | 100% | 2 | $50 |
| | 12-7a | 7 | $25 | $175 | 0% | 0 | $— | 0% | 0 | $— | 0% | 0 | $— |
| Wed | 7:a-3 | 8 | $25 | $200 | 20% | 1.6 | $40 | 40% | 3.2 | $80 | 100% | 8 | $200 |
| | 3:p-10 | 7 | $40 | $280 | 20% | 1.4 | $56 | 40% | 2.8 | $112 | 100% | 7 | $280 |
| | 10-12 | 2 | $25 | $50 | 0% | 0 | $— | 0% | 0 | $— | 100% | 2 | $50 |
| | 12-7a | 7 | $25 | $175 | 0% | 0 | $— | 0% | 0 | $— | 0% | 0 | $— |
| Thurs | 7:a-3 | 8 | $25 | $200 | 20% | 1.6 | $40 | 40% | 3.2 | $80 | 100% | 8 | $200 |
| | 3:p-10 | 7 | $40 | $280 | 20% | 1.4 | $56 | 40% | 2.8 | $112 | 100% | 7 | $280 |
| | 10-12 | 2 | $25 | $50 | 0% | 0 | $— | 0% | 0 | $— | 100% | 2 | $50 |
| | 12-7a | 7 | $25 | $175 | 0% | 0 | $— | 0% | 0 | $— | 0% | 0 | $— |
| Fri | 7:a-3 | 8 | $25 | $200 | 20% | 1.6 | $40 | 40% | 3.2 | $80 | 100% | 8 | $200 |
| | 3:p-10 | 7 | $40 | $280 | 20% | 1.4 | $56 | 40% | 2.8 | $112 | 100% | 7 | $280 |
| | 10-12 | 2 | $25 | $50 | 0% | 0 | $— | 0% | 0 | $— | 100% | 2 | $50 |
| | 12-7a | 7 | $25 | $175 | 0% | 0 | $— | 0% | 0 | $— | 0% | 0 | $— |
| Sat | 7:a-3 | 11 | $25 | $200 | 20% | 2.2 | $88 | 40% | 4.4 | $176 | 100% | 11 | $440 |
| | 3:p-10 | 4 | $40 | $280 | 20% | 0.8 | $32 | 40% | 1.6 | $64 | 100% | 4 | $160 |
| | 10-12 | 2 | $25 | $50 | 0% | 0 | $— | 0% | 0 | $— | 100% | 2 | $50 |
| | 12-7a | 7 | $25 | $175 | 0% | 0 | $— | 0% | 0 | $— | 0% | 0 | $— |
| Sun | 7:a-3 | 11 | $25 | $200 | 20% | 2.2 | $88 | 40% | 4.4 | $176 | 100% | 11 | $440 |
| | 3:p-10 | 4 | $40 | $280 | 20% | 0.8 | $32 | 40% | 1.6 | $64 | 100% | 4 | $160 |
| | 10-12 | 2 | $25 | $50 | 0% | 0 | $— | 0% | 0 | $— | 100% | 2 | $50 |
| | 12-7a | 7 | $25 | $175 | 0% | 0 | $— | 0% | 0 | $— | 0% | 0 | $— |

| | | | |
|---|---|---|---|
| Hours per Week | 10.5 | 21 | 119 |
| Weekly Gross Multi-Use Courts | $360 | $720 | $3,950 |
| # of Courts | 3 | 3 | 3 |
| Weekly Gross Multi-Use Courts | $1,080 | $2,160 | $11,850 |
| Annual Income | $56,160 | $112,320 | $616,200 |

Turf Fields

| | | | Rate | | | | | | | | | | |
|---|---|---|---|---|---|---|---|---|---|---|---|---|---|
| | | # | Per | Pot'l | Est. | Hrs | Gross | Est. | Hrs | Gross | Est. | Hrs | Gross |
| | | hr | Hr. | Income | Usage | Used | Rev | Usage | Used | Rev | Usage | Used | Rev |
| Mon | 7:a-3 | 8 | $150 | $1,200 | 0% | 0 | $— | 0% | 0 | $— | 100% | 8 | $1,200 |
| | 3:p-10 | 7 | $150 | $1,050 | 20% | 1.4 | $210 | 40% | 2.8 | $420 | 100% | 7 | $1,050 |
| | 10-12 | 2 | $150 | $300 | 0% | 0 | $— | 0% | 0 | $— | 100% | 2 | $300 |
| | 12-7a | 7 | $150 | $1,050 | 0% | 0 | $— | 0% | 0 | $— | 0% | 0 | $— |
| Tues | 7:a-3 | 8 | $150 | $1,200 | 0% | 0 | $— | 0% | 0 | $— | 100% | 8 | $1,200 |
| | 3:p-10 | 7 | $150 | $1,050 | 20% | 1.4 | $210 | 40% | 2.8 | $420 | 100% | 7 | $1,050 |
| | 10-12 | 2 | $150 | $300 | 0% | 0 | $— | 0% | 0 | $— | 100% | 2 | $300 |
| | 12-7a | 7 | $150 | $1,050 | 0% | 0 | $— | 0% | 0 | $— | 0% | 0 | $— |
| Wed | 7:a-3 | 8 | $150 | $1,200 | 0% | 0 | $— | 0% | 0 | $— | 100% | 8 | $1,200 |
| | 3:-10 | 7 | $150 | $1,050 | 20% | 1.4 | $210 | 40% | 2.8 | $420 | 100% | 7 | $1,050 |
| | 10-12 | 2 | $150 | $300 | 0% | 0 | $— | 0% | 0 | $— | 100% | 2 | $300 |
| | 12-7a | 7 | $150 | $1,050 | 0% | 0 | $— | 0% | 0 | $— | 0% | 0 | $— |
| Thur | 7:a-3 | 8 | $150 | $1,200 | 0% | 0 | $— | 0% | 0 | $— | 100% | 8 | $1,200 |
| | 3:p 10 | 7 | $150 | $1,050 | 20% | 1.4 | $210 | 40% | 2.8 | $420 | 100% | 7 | $1,050 |
| | 10-12 | 2 | $150 | $300 | 0% | 0 | $— | 0% | 0 | $— | 100% | 2 | $300 |
| | 12-7a | 7 | $150 | $1,050 | 0% | 0 | $— | 0% | 0 | $— | 0% | 0 | $— |
| Fri | 7:a-3 | 8 | $150 | $1,200 | 0% | 0 | $— | 0% | 0 | $— | 100% | 8 | $1,200 |
| | 3:p-10 | 7 | $150 | $1,050 | 20% | 1.4 | $210 | 40% | 2.8 | $420 | 100% | 7 | $1,050 |
| | 10-12 | 2 | $150 | $300 | 0% | 0 | $— | 0% | 0 | $— | 100% | 2 | $300 |
| | 12-7a | 7 | $150 | $1,050 | 0% | 0 | $— | 0% | 0 | $— | 0% | 0 | $— |
| Sat | 7:a-3 | 11 | $150 | $650 | 20% | 2.2 | $330 | 40% | 4.4 | $660 | 100% | 11 | $1,650 |
| | 3:p 10 | 4 | $150 | $600 | 20% | 0.8 | $120 | 40% | 1.6 | $240 | 100% | 4 | $600 |
| | 10-12 | 2 | $150 | $300 | 0% | 0 | $— | 0% | 0 | $— | 100% | 2 | $300 |
| | 12-7a | 7 | $150 | $1,050 | 0% | 0 | $— | 0% | 0 | $— | 0% | 0 | $— |
| Sun | 7:a-3 | 11 | $150 | $1,650 | 20% | 2.2 | $330 | 40% | 4.4 | $660 | 100% | 11 | $1,650 |
| | 3:p-10 | 4 | $150 | $600 | 20% | 0.8 | $120 | 40% | 1.6 | $240 | 100% | 4 | $600 |
| | 10-12 | 2 | $150 | $300 | 0% | 0 | $— | 0% | 0 | $— | 100% | 2 | $300 |
| | 12-7a | 7 | $150 | $1,050 | 0% | 0 | $— | 0% | 0 | $— | 0% | 0 | $— |

| | | | |
|---|---|---|---|
| Hours per Week | 13 | 39 | 119 |
| Weekly Gross per Annex | $1,950 | $5,850 | $17,850 |
| Field | | | |
| # of Fields | 5 | 5 | 5 |
| Weekly Gross Income All | $9,750 | $29,250 | $89,250 |
| Fields | | | |
| Annual Income | $507,000 | $1,521,000 | $4,641,000 |

Arena

| | | | Rate | | | | | | | |
|---|---|---|---|---|---|---|---|---|---|---|
| | | # | Per | Pot'l | Est. | Hrs | Gross | Est. | Hrs | Gross |
| | | hrs | Hr. | Rev | Usage | Used | Rev | Usage | Used | Rev |
| Mon | 7:a-3 | 8 | $600 | $4,800 | 0% | 0 | $0 | 10% | 0.8 | $480 |
| | 3:p-10 | 7 | $600 | $4,200 | 5% | 0.35 | $210 | 30% | 2.1 | $1,260 |
| | 10:-3 | 2 | $600 | $1,200 | 0% | 0 | $0 | 10% | 0.2 | $120 |
| | 12-7a | 7 | $600 | $4,200 | 0% | 0 | $0 | 0% | 0 | $0 |
| Tues | 7:a-3 | 8 | $600 | $4,800 | 0% | 0 | $0 | 10% | 0.8 | $480 |
| | 3:p-10 | 7 | $600 | $4,200 | 5% | 0.35 | $210 | 30% | 2.1 | $1,260 |
| | 10:-3 | 2 | $600 | $1,200 | 0% | 0 | $0 | 10% | 0.2 | $120 |
| | 12-7a | 7 | $600 | $4,200 | 0% | 0 | $0 | 0% | 0 | $0 |
| Wed | 7:a-3 | 8 | $600 | $4,800 | 0% | 0 | $0 | 10% | 0.8 | $480 |
| | 3:p-10 | 7 | $600 | $4,200 | 5% | 0.35 | $210 | 30% | 2.1 | $1,260 |
| | 10:-3 | 2 | $600 | $1,200 | 0% | 0 | $0 | 10% | 0.2 | $120 |
| | 12-7a | 7 | $600 | $4,200 | 0% | 0 | $0 | 0% | 0 | $0 |
| Thur | 7:a-3 | 8 | $600 | $4,800 | 0% | 0 | $0 | 10% | 0.8 | $480 |
| | 3:p-10 | 7 | $600 | $4,200 | 5% | 0.35 | $210 | 30% | 2.1 | $1,260 |
| | 10:-3 | 2 | $600 | $1,200 | 0% | 0 | $0 | 10% | 0.2 | $120 |
| | 12-7a | 7 | $600 | $4,200 | 0% | 0 | $0 | 0% | 0 | $0 |
| Fri | 7:a-3 | 8 | $600 | $4,800 | 0% | 0 | $0 | 10% | 0.8 | $480 |
| | 3:p-10 | 7 | $600 | $4,200 | 5% | 0.35 | $210 | 30% | 2.1 | $1,260 |
| | 10:-3 | 2 | $600 | $1,200 | 0% | 0 | $0 | 10% | 0.2 | $120 |
| | 12-7a | 7 | $600 | $4,200 | 0% | 0 | $0 | 0% | 0 | $0 |
| Sat | 7:a-3 | 11 | $600 | $6,600 | 30% | 3.3 | $1,980 | 75% | 8.25 | $4,950 |
| | 3:p-10 | 4 | $600 | $2,400 | 30% | 1.2 | $720 | 75% | 3 | $1,800 |
| | 10:-3 | 2 | $600 | $1,200 | 0% | 0 | $0 | 10% | 0.2 | $120 |
| | 12-7a | 7 | $600 | $4,200 | 0% | 0 | $0 | 0% | 0 | $0 |
| Sun | 7:a-3 | 11 | $600 | $6,600 | 20% | 2.2 | $1,320 | 75% | 8.25 | $4,950 |
| | 3:p-10 | 4 | $600 | $2,400 | 20% | 0.8 | $480 | 75% | 3 | $1,800 |
| | 10:-3 | 2 | $600 | $1,200 | 0% | 0 | $0 | 10% | 0.2 | $120 |
| | 12-7a | 7 | $600 | $4,200 | 0% | 0 | $0 | 0% | 0 | $0 |

| | | | | |
|---|---|---|---|---|
| Hours per Week | 9.25 | 15.7 | 28.45 | 38.4 |
| Weekly Gross | 5550 | 9420 | 17070 | 23040 |
| Income Arena | | | | |
| Annual Income | 288600 | 489840 | 887640 | 1198080 |

Conference Center

| | | | | | | Price | |
|---|---|---|---|---|---|---|---|
| # of | | | | Size | Total | Per | Total |
| Units | L′ | Size | W′ | Sq. Ft. | Sq. Ft. | Day | Unit Price |
| 3 | 25 | x | 25 | 625 | 1875 | $200 | $600 |
| 1 | 50 | x | 50 | 2500 | 2500 | $500 | $500 |
| TOTAL | | | | | 4375 | | $1,100 |
| | | | | Days/Year | 25 | Total | $27,500 |
| | | | | Days/Year | 50 | Total | $55,000 |
| | | | | Days/Year | 75 | Total | $82,500 |
| | | | | Days/Year | 100 | Total | $110,000 |

Concessations

| | | Esti- | | | |
|---|---|---|---|---|---|
| | An- | mated | | | |
| | nual | Ex- | | 33% | |
| | Pa- | pendi- | Estimated | Cost of | Estimated |
| | trons | ture | Sales | Goods | Profit |
| Concessions | 75000 | $5 | $375,000 | $123,750 | $251,250 |
| Concessions | 150000 | $5 | $750,000 | $247,500 | $502,500 |
| Concessions | 300000 | $5 | $1,500,000 | $495,000 | $1,005,000 |
| Concessions | 500000 | $5 | $2,500,000 | $825,000 | $1,675,000 |

Advertising

| | Unit | | | | |
|---|---|---|---|---|---|
| | | Price | | Monthly | Annual |
| | # of | Per | Monthly | All | All |
| Description | Units | Year | Per Unit | Units | Units |
| Facility | 0 | $250,000 | $20,833.33 | $— | $— |
| Sponsor | | | | | |
| Pod Sponsor | 5 | $5,000 | $417 | $2,083 | $25,000 |
| Court Floor | 16 | $5,000 | $417 | $6,667 | $80,000 |
| Sponsor | | | | | |
| Court Wall | 16 | $1,500 | $125 | $2,000 | $24,000 |
| Sponsor | | | | | |
| Court Goals | 16 | $2,500 | $208 | $3,333 | $40,000 |
| Court | 16 | $2,500 | $208 | $3,333 | $40,000 |
| Scoreboards | | | | | |
| Turf Field | 5 | $3,000 | $250 | $1,250 | $15,000 |
| Sponsor | | | | | |
| Turf Field | 8 | $1,000 | $83 | $667 | $8,000 |
| Wall Sponsor | | | | | |
| Playground | 2 | $2,500 | $208 | $417 | $5,000 |
| Sponsor | | | | | |
| Batting Cages | 1 | $2,500 | $208 | $208 | $2,500 |
| Total | 85 | | | $19,958 | $239,500 |

| | | | |
|---|---|---|---|
| Percentage | 40% | Annual Total | $95,800 |
| Percentage | 60% | Annual Total | $143,700 |
| Percentage | 80% | Annual Total | $191,600 |
| Percentage | 100% | Annual Total | $239,500 |

Preliminary Budget Analysis

BXXX ARCHITECTS MEB CLIENT: the-ROCC, LLC
LOCATION: Hamilton County, Indiana
PROJECT TYPE: Sports/Office Complex

| | DESCRIPTION | | | |
|---|---|---|---|---|
| | OF WORK | SCHEDULED | VENDER | % |
| | SOFT COSTS | | | |
| 1 | Architectural/ | $450,000.00 | estimated | 1.17% |
| | Engineering | | | |
| 2 | Civil | $200,000.00 | estimated | 0.52% |
| | Engineering | | | |
| 3 | Construction | $500,000.00 | estimated | 1.30% |
| | Mgmt. Fee | | | |
| 4 | Local Filing | | proposed | |
| | & Review Fees | | | |
| 5 | State Review | $50,000.00 | estimated | 0.13% |
| | Fees | | | |
| 6 | Legal Fees | $150,000.00 | estimated | 0.39% |
| 7 | Surveys and | $25,000.00 | estimated | 0.06% |
| | Testing | | | |
| 8 | Building | | proposed | |
| | Permits | | | |
| 9 | Road Impact | | proposed | |
| | Fee | | | |
| 10 | Utility Tap | $275,000.00 | estimated | 0.71% |
| | Fees | | | |
| 11 | CPA/ | $25,000.00 | estimated | 0.06% |
| | Accounting | | | |
| 12 | Insurance | $150,000.00 | estimated | 0.39% |
| | Builders Risk | | | |
| 13 | Interest Only | | estimated | |
| 14 | 13 Month | | estimated | |
| | Operating | | | |
| | Budget | | | |
| 15 | SITE | $4,750,000.00 | estimated | 12.31% |
| | DEVELOPMENT | | | |
| | COSTS | | | |
| 16 | General | $225,000.00 | | 0.58% |
| | Construction | | | |
| | Costs | | | |
| 17 | Excavating | included in | | |
| | | Site Cost | | |
| 18 | Erosion | included in | | |
| | Control | Site Cost | | |
| 19 | Sanitary | included in | | |
| | Sewer | Site Cost | | |
| 20 | On Site Water | included in | | |
| | | Site Cost | | |
| 21 | Storm Sewer | included in | | |
| | | Site Cost | | |
| 22 | Subsurface | included in | | |
| | Drainage | Site Cost | | |
| 23 | Conduits | included in | | |
| | | Site Cost | | |
| 24 | Soil | included in | | |
| | Stabilization | Site Cost | | |
| 25 | Stone and | included in | | |
| | Paving | Site Cost | | |
| 26 | Walking Path | | | |
| 27 | Irrigation | | | |
| | System | | | |
| 28 | Concrete Curb | | | |
| | and Sidewalk | | | |
| 29 | Landscaping | included in | | |
| | | Site Cost | | |
| | CONTINGENCIES | | | |
| 30 | CONTINGENCIES | $750,000 | | 1.94% |
| 31 | LAND COSTS | $3,000,000 | | 7.78% |
| | (assumed) | | | |
| | BUILDING | | | |
| | COSTS | | | |
| 32 | Concrete Wall | $410,000 | Builders | 1.06% |
| | Footings | | Concrete | |
| 33 | Concrete | $215,000 | Builders | 0.56% |
| | Column | | Concrete | |
| | Footings | | | |
| 34 | Concrete Slab | $1,120,000 | Builders | 2.90% |
| | on Grade | | Concrete | |
| 35 | Pre-Cast | $3,325,000 | estimated | 8.62% |
| | Concrete | | | |
| | Walls | | | |
| 36 | Pre-Cast | $2,500,000 | estimated | 6.48% |
| | Concrete | | | |
| | Floors | | | |
| 37 | Masonry | $665,000 | Bolt A Block | 1.72% |
| 38 | Roof Joists | $2,300,000 | estimated | 5.96% |
| | and Deck | | | |
| 39 | Stadium Roof | $2,750,000 | estimated | 7.13% |
| | Trusses, | | | |
| | Joists, Deck | | | |
| 40 | Mezzanine | $100,000 | estimated | 0.26% |
| | Steel | | | |
| | Railings and | | | |
| | Stairs | | | |
| 41 | Executive | $128,000 | estimated | 0.33% |
| | Office Walls - | | | |
| | Exterior | | | |
| 42 | Executive | $425,000 | estimated | 1.10% |
| | Office Walls - | | | |
| | Interior | | | |
| 43 | Storage Room | $15,000 | estimated | 0.04% |
| | Walls | | | |
| 44 | Counter Tops | $55,000 | estimated | 0.14% |
| | and Cabinets | | | |
| 45 | Membrane | $1,700,000 | estimated | 4.41% |
| | Roofing & | | | |
| | Insulation | | | |
| 46 | Windows | $38,000 | estimated | 0.10% |
| 47 | Doors &Frames | $583,500 | estimated | 1.51% |
| 48 | Roll Up Doors | $44,000 | estimated | 0.11% |
| 49 | Overhead | $54,000 | estimated | 0.14% |
| | Doors | | | |
| 50 | Aluminum | $310,000 | estimated | 0.80% |
| | Store Front | | | |
| 51 | Flooring | $75,000 | estimated | 0.19% |
| | (non-sport) | | | |
| 52 | Ext. Painting | $300,000 | estimated | 0.78% |
| | and Finishes | | | |
| 53 | Int. Painting | $100,000 | estimated | 0.26% |
| | and Trim | | | |
| 54 | Pre- | $2,400,000 | estimated | 6.22% |
| | Engineered | | | |
| | Metal | | | |
| | Buildings | | | |
| 55 | Elevators | $80,000 | estimated | 0.21% |
| 56 | Interior | $20,000 | estimated | 0.05% |
| | Signage & | | | |
| | Lettering | | | |
| 57 | Fire | | | |
| | Extinguishers | | | |
| 58 | Plumbing & | $730,500 | estimated | 1.89% |
| | Fixtures | | | |
| 59 | HVAC | $1,500,000 | estimated | 3.89% |
| 60 | Electrical | $1,800,000 | estimated | 4.67% |
| | Lighting and | | | |
| | Power | | | |
| | ADDITIONAL | | | |
| | ITEMS | | | |
| 61 | Signage | $100,000 | estimated | 0.26% |
| 62 | Inventory | | | |
| 63 | Management | $75,000 | estimated | 0.19% |
| | Computers | | | |
| 64 | Maintenance | $100,000 | estimated | 0.26% |
| | Equipment | | | |
| 65 | Basketball | $216,000 | Midwest Sports | 0.56% |
| | Goals | | Products | |
| 66 | Scoreboards | $96,000 | Midwest Sports | 0.25% |
| | | | Products | |
| 67 | Team Benches | | | |
| 68 | Scorers | | | |
| | Tables | | | |
| 69 | Volleyball | $56,000 | Midwest Sports | 0.15% |
| | Nets | | Products | |
| 70 | Soccer Goals | $12,000 | Midwest Sports | 0.03% |
| | | | Products | |
| 71 | Football | $7,000 | Midwest Sports | 0.02% |
| | Goals | | Products | |
| 72 | Turf Field | $850,000 | Midwest Sports | 2.20% |
| | | | Products | |
| 73 | Hardwood | $1,000,000 | Cincinnati | 2.59% |
| | Courts | | Flooring | |
| | | | (Robbins) | |
| 74 | Synthetic | $100,000 | estimate | 0.26% |
| | Flooring | | | |
| | (Pods 5/6) | | | |
| 75 | Athletic | $235,000 | estimate | 0.61% |
| | Flooring | | | |
| | (Annex) | | | |
| 76 | Mezzanine | $25,000 | estimate | 0.06% |
| | Tables | | | |
| 77 | Mezzanine | $40,000 | estimate | 0.10% |
| | Stools | | | |
| 78 | Commons | $25,000 | estimate | 0.06% |
| | Tables | | | |
| 79 | Banquet | $10,000 | estimate | 0.03% |
| | Tables | | | |
| 80 | Banquet | $10,000 | estimate | 0.03% |
| | Chairs | | | |
| 81 | Permanent | $1,000,000 | Interkal | 2.59% |
| | Bleachers | | | |
| 82 | Stadium Seats | | | |
| 83 | Fold Out | | | |
| | Bleachers | | | |
| 84 | Furniture | $100,000 | estimated | 0.26% |
| 85 | Phone System | $10,000 | estimated | 0.03% |
| 86 | Projectors - | $20,000 | estimated | 0.05% |
| | Conference | | | |
| | Rooms | | | |
| 87 | Monitoring | $200,000 | estimated | 0.52% |
| | System | | | |
| 88 | TOTAL VALUE | $38,580,000 | | 100% |

Projected Cash Flow

Potential Income $3,519,358

| | Year One | Year Two | Year Three | Year Four | Year Five |
|---|---|---|---|---|---|
| 2% Growth | | | | | |
| per month: | | | | | |
| Projected | $844,646 | $1,689,292 | $2,533,938 | $3,378,583 | $3,519,358 |
| Income | | | | | |
| Total | ($3,241,540) | ($3,306,371) | ($3,371,202) | ($3,436,032) | ($3,500,863) |
| Expenses | | | | | |
| Debt | ($2,160,000) | ($2,160,000) | ($2,160,000) | ($2,160,000) | ($2,160,000) |
| Service | | | | | |
| Cash Flow | ($4,556,894) | ($3,777,079) | ($2,997,264) | ($2,217,449) | ($2,141,505) |
| 3% Growth | | | | | |
| per month: | | | | | |
| Projected | $1,266,969 | $2,533,938 | $3,519,358 | | |
| Income | | | | | |
| Total | ($3,241,540) | ($3,306,371) | ($3,371,202) | | |
| Expenses | | | | | |
| Debt | ($2,160,000) | ($2,160,000) | ($2,160,000) | | |
| Service | | | | | |
| Cash Flow | ($4,134,571) | ($2,932,433) | ($2,011,844) | | |
| 4% Growth | | | | | |
| per month: | | | | | |
| Projected | $1,689,292 | $3,378,583 | $3,519,358 | | |
| Income | | | | | |
| Total | ($3,241,540) | ($3,306,371) | ($3,371,202) | | |
| Expenses | | | | | |
| Debt | ($2,160,000) | ($2,160,000) | ($2,160,000) | | |
| Service | | | | | |
| Cash Flow | ($3,712,248) | ($2,087,787) | ($2,011,844) | | |
| 5% Growth | | | | | |
| per month: | | | | | |
| Projected | $2,111,615 | $3,519,358 | | | |
| Income | | | | | |
| Total | ($3,241,540) | ($3,306,371) | | | |
| Expenses | | | | | |
| Debt | ($2,160,000) | ($2,160,000) | | | |
| Service | | | | | |
| Cash Flow | ($3,289,925) | ($1,947,013) | | | |

Debt Service of $24,000,000.00 amortized over 25 years at 5% - Pre-leasing has not been considered in Projected Income totals. Assuming 2% annual increase of Total Expenses

Potential Growth 1%

| Potential | Growth |
|---|---|
| Income | Factor |
| $3,519,357 | 1% |

| Month | |
|---|---|
| | Year One |
| | Projected |
| | Income |
| 1 | $35,194 |
| 2 | $70,387 |
| 3 | $105,581 |
| 4 | $140,774 |
| 5 | $175,968 |
| 6 | $211,161 |
| 7 | $246,355 |
| 8 | $281,549 |
| 9 | $316,742 |
| 10 | $351,936 |
| 11 | $387,129 |
| 12 | $422,323 |
| | Year Two |
| | Projected |
| | Income |
| 13 | $457,517 |
| 14 | $492,710 |
| 15 | $527,904 |
| 16 | $563,097 |
| 17 | $598,291 |
| 18 | $633,484 |
| 19 | $668,678 |
| 20 | $703,872 |
| 21 | $739,065 |
| 22 | $774,259 |
| 23 | $809,452 |
| 24 | $844,646 |
| | Year Three |
| | Projected |
| | Income |
| 25 | $879,839 |
| 26 | $915,033 |
| 27 | $950,227 |
| 28 | $985,420 |
| 29 | $1,020,614 |
| 30 | $1,055,807 |
| 31 | $1,091,001 |
| 32 | $1,126,194 |
| 33 | $1,161,388 |
| 34 | $1,196,582 |
| 35 | $1,231,775 |
| 36 | $1,266,969 |
| | Year Four |
| | Projected |
| | Income |
| 37 | $1,302,162 |
| 38 | $1,337,356 |
| 39 | $1,372,550 |
| 40 | $1,407,743 |
| 41 | $1,442,937 |
| 42 | $1,478,130 |
| 43 | $1,513,324 |
| 44 | $1,548,517 |
| 45 | $1,583,711 |
| 46 | $1,618,905 |
| 47 | $1,654,098 |
| 48 | $1,689,292 |
| | Year Five |
| | Projected |
| | Income |
| 49 | $1,724,485 |
| 50 | $1,759,679 |
| 51 | $1,794,872 |
| 52 | $1,830,066 |
| 53 | $1,865,260 |
| 54 | $1,900,453 |
| 55 | $1,935,647 |
| 56 | $1,970,840 |
| 57 | $2,006,034 |
| 58 | $2,041,228 |
| 59 | $2,076,421 |
| 60 | $2,111,615 |
| | Year Six |
| | Projected |
| | Income |
| 61 | $2,146,808 |
| 62 | $2,182,002 |
| 63 | $2,217,195 |
| 64 | $2,252,389 |
| 65 | $2,287,583 |
| 66 | $2,322,776 |
| 67 | $2,357,970 |
| 68 | $2,393,163 |
| 69 | $2,428,357 |
| 70 | $2,463,550 |
| 71 | $2,498,744 |
| 72 | $2,533,938 |
| | Year Seven |
| | Projected |
| | Income |
| 73 | $2,569,131 |
| 74 | $2,604,325 |
| 75 | $2,639,518 |
| 76 | $2,674,712 |
| 77 | $2,709,906 |
| 78 | $2,745,099 |
| 79 | $2,780,293 |
| 80 | $2,815,486 |
| 81 | $2,850,680 |
| 82 | $2,885,873 |
| 83 | $2,921,067 |
| 84 | $2,956,261 |
| | Year Eight |
| | Projected |
| | Income |
| 85 | $2,991,454 |
| 86 | $3,026,648 |
| 87 | $3,061,841 |
| 88 | $3,097,035 |
| 89 | $3,132,228 |
| 90 | $3,167,422 |
| 91 | $3,202,616 |
| 92 | $3,237,809 |
| 93 | $3,273,003 |
| 94 | $3,308,196 |
| 95 | $3,343,390 |
| 96 | $3,378,583 |

Potential Growth 2%

| Potential Income | Growth Factor |
|---|---|
| $3,519,357.80 | 2% |

| | Projected |
|---|---|
| Month | Income |
| | Year One |
| 1 | $70,387 |
| 2 | $140,774 |
| 3 | $211,161 |
| 4 | $281,549 |
| 5 | $351,936 |
| 6 | $422,323 |
| 7 | $492,710 |
| 8 | $563,097 |
| 9 | $633,484 |
| 10 | $703,872 |
| 11 | $774,259 |
| 12 | $844,646 |
| | Year Two |
| 13 | $915,033 |
| 14 | $985,420 |
| 15 | $1,055,807 |
| 16 | $1,126,194 |
| 17 | $1,196,582 |
| 18 | $1,266,969 |
| 19 | $1,337,356 |
| 20 | $1,407,743 |
| 21 | $1,478,130 |
| 22 | $1,548,517 |
| 23 | $1,618,905 |
| 24 | $1,689,292 |
| | Year Three |
| 25 | $1,759,679 |
| 26 | $1,830,066 |
| 27 | $1,900,453 |
| 28 | $1,970,840 |
| 29 | $2,041,228 |
| 30 | $2,111,615 |
| 31 | $2,182,002 |
| 32 | $2,252,389 |
| 33 | $2,322,776 |
| 34 | $2,393,163 |
| 35 | $2,463,550 |
| 36 | $2,533,938 |
| | Year Four |
| 37 | $2,604,325 |
| 38 | $2,674,712 |
| 39 | $2,745,099 |
| 40 | $2,815,486 |
| 41 | $2,885,873 |
| 42 | $2,956,261 |
| 43 | $3,026,648 |
| 44 | $3,097,035 |
| 45 | $3,167,422 |
| 46 | $3,237,809 |
| 47 | $3,308,196 |
| 48 | $3,378,583 |

Potential Growth 3%

| Potential Income | Growth Factor |
|---|---|
| $3,519,357.80 | 3% |

| | Projected |
|---|---|
| Month | Income |
| | Year One |
| 1 | $105,581 |
| 2 | $211,161 |
| 3 | $316,742 |
| 4 | $422,323 |
| 5 | $527,904 |
| 6 | $633,484 |
| 7 | $739,065 |
| 8 | $844,646 |
| 9 | $950,227 |
| 10 | $1,055,807 |
| 11 | $1,161,388 |
| 12 | $1,266,969 |
| | Year Two |
| 13 | $1,372,550 |
| 14 | $1,478,130 |
| 15 | $1,583,711 |
| 16 | $1,689,292 |
| 17 | $1,794,872 |
| 18 | $1,900,453 |
| 19 | $2,006,034 |
| 20 | $2,111,615 |
| 21 | $2,217,195 |
| 22 | $2,322,776 |
| 23 | $2,428,357 |
| 24 | $2,533,938 |
| | Year Three |
| 25 | $2,639,518 |
| 26 | $2,745,099 |
| 27 | $2,850,680 |
| 28 | $2,956,261 |
| 29 | $3,061,841 |
| 30 | $3,167,422 |
| 31 | $3,273,003 |
| 32 | $3,378,583 |
| 33 | $3,484,164 |
| 34 | $3,589,745 |
| 35 | $3,695,326 |
| 36 | $3,800,906 |
| | Year Four |
| 37 | $3,906,487 |
| 38 | $4,012,068 |
| 39 | $4,117,649 |
| 40 | $4,223,229 |
| 41 | $4,328,810 |
| 42 | $4,434,391 |
| 43 | $4,539,972 |
| 44 | $4,645,552 |
| 45 | $4,751,133 |
| 46 | $4,856,714 |
| 47 | $4,962,294 |
| 48 | $5,067,875 |

Potential Growth 4%

| Potential Income | Growth Factor |
|---|---|
| $3,519,357.80 | 4% |

| Month | Projected Income |
|---|---|
| | Year One |
| 1 | $140,774 |
| 2 | $281,549 |
| 3 | $422,323 |
| 4 | $563,097 |
| 5 | $703,872 |
| 6 | $844,646 |
| 7 | $985,420 |
| 8 | $1,126,194 |
| 9 | $1,266,969 |
| 10 | $1,407,743 |
| 11 | $1,548,517 |
| 12 | $1,689,292 |
| | Year Two |
| 13 | $1,830,066 |
| 14 | $1,970,840 |
| 15 | $2,111,615 |
| 16 | $2,252,389 |
| 17 | $2,393,163 |
| 18 | $2,533,938 |
| 19 | $2,674,712 |
| 20 | $2,815,486 |
| 21 | $2,956,261 |
| 22 | $3,097,035 |
| 23 | $3,237,809 |
| 24 | $3,378,583 |
| | Year Three |
| 25 | $3,519,358 |
| 26 | $3,660,132 |
| 27 | $3,800,906 |
| 28 | $3,941,681 |
| 29 | $4,082,455 |
| 30 | $4,223,229 |
| 31 | $4,364,004 |
| 32 | $4,504,778 |
| 33 | $4,645,552 |
| 34 | $4,786,327 |
| 35 | $4,927,101 |
| 36 | $5,067,875 |
| | Year Four |
| 37 | $5,208,650 |
| 38 | $5,349,424 |
| 39 | $5,490,198 |
| 40 | $5,630,972 |
| 41 | $5,771,747 |
| 42 | $5,912,521 |
| 43 | $6,053,295 |
| 44 | $6,194,070 |
| 45 | $6,334,844 |
| 46 | $6,475,618 |
| 47 | $6,616,393 |
| 48 | $6,757,167 |

Potential Growth 5%

| Potential Income | Growth Factor |
|---|---|
| $3,519,357.80 | 5% |

| | Projected |
|---|---|
| Month | Income |
| | Year One |
| 1 | $175,968 |
| 2 | $351,936 |
| 3 | $527,904 |
| 4 | $703,872 |
| 5 | $879,839 |
| 6 | $1,055,807 |
| 7 | $1,231,775 |
| 8 | $1,407,743 |
| 9 | $1,583,711 |
| 10 | $1,759,679 |
| 11 | $1,935,647 |
| 12 | $2,111,615 |
| | Year Two |
| 13 | $2,287,583 |
| 14 | $2,463,550 |
| 15 | $2,639,518 |
| 16 | $2,815,486 |
| 17 | $2,991,454 |
| 18 | $3,167,422 |
| 19 | $3,343,390 |
| 20 | $3,519,358 |
| 21 | $3,695,326 |
| 22 | $3,871,294 |
| 23 | $4,047,261 |
| 24 | $4,223,229 |
| | Year Three |
| 25 | $4,399,197 |
| 26 | $4,575,165 |
| 27 | $4,751,133 |
| 28 | $4,927,101 |
| 29 | $5,103,069 |
| 30 | $5,279,037 |
| 31 | $5,455,005 |
| 32 | $5,630,972 |
| 33 | $5,806,940 |
| 34 | $5,982,908 |
| 35 | $6,158,876 |
| 36 | $6,334,844 |
| | Year Four |
| 37 | $6,510,812 |
| 38 | $6,686,780 |
| 39 | $6,862,748 |
| 40 | $7,038,716 |
| 41 | $7,214,683 |
| 42 | $7,390,651 |
| 43 | $7,566,619 |
| 44 | $7,742,587 |
| 45 | $7,918,555 |
| 46 | $8,094,523 |
| 47 | $8,270,491 |
| 48 | $8,446,459 |

What is claimed is:

1. A Special Business Method for determining the Financial Viability of Constructing a Recreation Center comprised of the following steps:
A Step 1: Select Geographical Area for Project Study;
A Step 2: Determine Local Support and Governing Bodies;
A Step 3: Select Cornerstone Sport;
A Step 4: Obtain Local Demographics;
A Step 5: Complete Financial Analysis & Project Options for Scope;
A Step 6: Select Scope & Original Size;
A Step 7: Review & Communicate;
A Step 8: Foster Public Awareness;
A Step 9: Obtain Local Approval;
A Step 10: Obtain Capital Financing;
A Step 11: Build;
A Step 12: Launch; and
A Step 13: Decide to Expand
wherein the sustainability of an operating profit, the cash flow of funds, the initial front-loading of capital; and a reasonable payback may be determined when associated with building a flexible recreational office and convention center for a give geographical area.

2. The business method in claim 1 wherein the Step 5 is comprised of:
A Step 5A. Select Project Study;
A Step 5B. Complete Income Analysis from Demographic;
Indicators (4)—Executive Offices, Shops and Studios, Hardwood Courts, Multiuse Floors, Turf Fields, Conference Centers, Concessions, Event Admissions, Community Pass, Advertising;
A Step 5C. Calculate/Estimate Expenses;
A Step 5D. Provide and Review Building Project Budget
A Step 5E. Complete Cash Flow Analysis
A Step 5F. Select Growth Options and Complete Aggressive and Conservative Options; and
A Step 5G. Present Options to Support Group for Scope and Size Selection.

3. A Flexible Commercial Center known as the ROCC is comprised of:
a. At least one Parking Lot;
b. At least one Fitness Center Utilization;
c. At least one Executive Office;
d. At least one Common Area;
e. At least one Recreational Studio;
f. At least one Retail Studio;
g. At least one Food Court;
h. At least one Hardwood Court Pod;
i. At least one Turf Pod;
j. Storage Area;
wherein all the elements are comprised of special features to result in a recreational, office and convention center with multiple functions and an ability to serve as a facility for many various sporting and civic events.

4. The commercial center according to claim 3 wherein the center is also comprised of:
a. Hotel
b. Plaza

5. The commercial center according to claim 3 wherein the pod is configured for use from the group consisting of football, futsal, soccer, softball, basketball, youth basketball, volleyball, lacrosse, tradeshow, food catering, ice skating, music concerts, and tennis.

6. The commercial center according to claim 3 wherein the recreation are is configured for use from the group consisting of climbing wall, shuffleboard, ping-pong, billiards/pool, batting cages and play area.
